(19) United States
(12) Patent Application Publication
(10) Pub. No.: US 2016/0165602 A1
(43) Pub. Date: Jun. 9, 2016

(54) COMMUNICATION SYSTEM, BASE STATION, WIRELESS EQUIPMENT, AND COMMUNICATION METHOD

(71) Applicant: FUJITSU LIMITED, Kawasaki-shi (JP)

(72) Inventor: KENJI SUDA, Yokohama (JP)

(73) Assignee: FUJITSU LIMITED, Kawasaki-shi (JP)

(21) Appl. No.: 15/040,240

(22) Filed: Feb. 10, 2016

Related U.S. Application Data
(63) Continuation of application No. PCT/JP2013/071909, filed on Aug. 14, 2013.

(51) Int. Cl. H04W 72/04; H04W 68/02; H04W 4/08; H04L 5/00

(52) U.S. Cl. CPC H04W 72/0446; H04L 5/0053; H04W 68/02; H04W 4/08; H04W 88/08

(57) ABSTRACT

A communication system includes a base station and a plurality of wireless equipments. The base station includes a segment notifying unit that notifies each of the wireless equipments of a segment designated value used for segmenting a data area into a plurality of segment areas, the data area corresponding to a transmission time interval of a shared Channel to be time-multiplexed on a transmission time interval basis between the base station and the wireless equipments, and a segment data setting unit that sets data addressed to the wireless equipment becoming a destination in the segment areas obtained by segmenting the data area based on the segment designated value. Each of the wireless equipments includes a self equipment data acquiring unit that searches for the segment area containing data addressed to a self wireless equipment from the received data area of the shared Channel corresponding to the interval.

### CROSS-REFERENCE TO RELATED APPLICATION

This application is a continuation application of International Application PCT/JP2013/071909 filed on Aug. 14, 2013 and designated the U.S., the entire contents of which are incorporated herein by reference.

### FIELD

The disclosures made herein pertain to a base station, a wireless equipment performing communications with the base station, and a communication system including the base station and the wireless equipment, and a communication method between the base station and the wireless equipment.

### BACKGROUND

In a technical field of wireless communications, a standardization organization called, e.g., 3GPP (3rd Generation Partnership Project) drafts and opens specifications to the public. Services based on specifications called LTE (Long Term Evolution) are started.

By the way, according to the specifications of the conventional wireless communications proposed by the standardization organization instanced by 3GPP and other equivalent organizations, a size of transmission unit data transmitted at unit time called a Transmission Time Interval (TTI) is equal to or larger than a predetermined limit on a communication path between UE (User Equipment) and a base station. An equipment instanced by UE and other equivalent equipments performing the wireless communications with the base station is hereinafter called a wireless equipment.

FIG. 1 illustrates a structure of the transmission unit data corresponding to the transmission time interval specified by the specifications of 3GPP. In the wireless communications, an area defined by a frequency axis for carrying data and a time axis is called a radio resource. In FIG. 1, the radio resource is expressed as a two-dimensional data area by a direction of the frequency axis and a direction of the time axis.

The transmission time interval is also called a sub-frame and may also be said to be a minimum time unit enabling allocation of the radio resource. A single segmentation of data called “symbol” is arrayed at the transmission time interval in the time-axis direction, and the data are thus transmitted. For example, according to 3GPP, the radio resource is segmented into a plurality of subcarriers in the direction of the frequency axis. To be specific, according to 3GPP, subcarriers are controlled batch-wise by predetermined numbers, e.g., by twelves. This is because the base station and the wireless equipment individually control and use the multiplicity of subcarriers, resulting in an increase of control data with a great amount of futility.

To be specific, the radio resources are allocated in the direction of the time axis batch-wise by the predetermined number of symbols to the wireless equipments. The radio resources are allocated in the direction of the frequency axis batch-wise by the plurality of subcarriers to the wireless equipments. The data corresponding to each of areas sectioned by the transmission time interval (the predetermined number of symbols) in the direction of the time axis and controlled batch-wise by the predetermined number of subcarriers in the direction of the frequency axis, will hereinafter be called transmission unit data. An area of the radio resource, which is used for carrying the transmission unit data and expressed by the frequency axis and the time axis, is also referred to as a resource block.

Part of the plurality of symbols in the transmission unit data are used for the control Channel. The symbols other than the control Channel are used as, e.g., a data Channel between the base station and the wireless equipment.

As described above, the radio resources in FIG. 1 are allocated by the predetermined number of subcarriers (e.g., 12 subcarriers) in the direction of the frequency axis to the wireless equipments instanced by UE1, UE2 and other equivalent equipments. The radio resources are also allocated to the single wireless equipment in the direction of the time axis without being multiplexed between the plural wireless equipments in the transmission time interval. Accordingly, supposing a case of encoding the data of 13 symbols and 2 resource blocks of 12 subcarriers byway of the transmission unit data of the radio resources as proposed by, e.g., 3GPP with turbo codes having a coded rate of ⅓ according to QPSK (Quadruple Phase Shift Keying), a size of the transmission unit data is given as below.

13 Symbols×24 Subcarriers×⅔=208 bits. Note that this size of transmission unit data is one example. For instance, when the transmission unit data is set to one resource block, it follows that the size of transmission unit data becomes 104 bits.

The following are related arts to the invention.

[Patent document 1] Japanese Patent Laid-Open Publication No. JP 2012-235340

[Patent document 2] Japanese Patent Laid-Open Publication No. JP 2012-235360

[Patent document 3] Japanese Patent Laid-Open Publication No. JP 2012-235354

[Patent document 4] Japanese Patent Laid-Open Publication No. JP 2012-235353

[Patent document 5] Japanese Patent Laid-Open Publication No. JP 2013-26641

[Patent document 6] Japanese Patent Laid-Open Publication No. JP 2011-501928

[Patent document 7] Japanese Patent Laid-Open Publication No. JP 2009-505518

[Patent document 8] Japanese Patent Laid-Open Publication No. JP 2008-538060

[Patent document 9] Japanese Patent Laid-Open Publication No. JP 2004-349884

### SUMMARY

As described above, according to the conventional wireless communication technology, one transmission unit data has a predetermined limit of size. By the way, the wireless communications from now into the future are expected to be applied to communications with a variety of devices instanced by MTC (Machine Type Communication) devices in addition to communications between a base station and mobile terminals defined as conventional wireless equipments. The communications of the devices instanced by the MTC devices and other equivalent devices are based on the assumption that a data traffic, e.g., a quantity of data transmitted and received by one session is smaller than the transmission unit data in the conventional wireless communication. Accordingly, when one piece of transmission unit data is used in the communications of the data smaller than the transmission unit data in a communication system between the base station and the wireless equipment, usage efficiency of the radio resources decreases.

Such a mechanism is therefore desired as to enable the data smaller than the transmission unit data to be transmitted and received and one piece of transmission unit data to be time-multiplexed between the plural wireless equipments. Such a method is considered that, e.g., the base station further time-division-multiplexes the transmission unit data in the communication with the wireless equipment in the direction of the time axis in a shorter period of time than the transmission time interval. However, when time-divided on the unit smaller than the transmission unit data, a possibility arises of increasing a control data quantity for the time division. In other words, the base station reduces the data quantity in the communication with the wireless equipment, while the control data quantity increases, resulting in no improvement of the usage efficiency of the radio resources.

According to one aspect, the following wireless communication system is exemplified. The communication system includes a base station, and a plurality of wireless equipments. The base station has a segment notifying unit that notifies each of the plurality of wireless equipments of a segment designated value used for segmenting a data area into a plurality of segment areas, the data area corresponding to a transmission time interval of a shared Channel to be time-multiplexed on a transmission time interval basis between the base station and the plurality of wireless equipments; and a segment data setting unit that sets data addressed to the wireless equipment becoming a destination in the segment areas obtained by segmenting the data area based on the segment designated value. Each of the plurality of wireless equipments has a self equipment data acquiring unit that searches for the segment area containing data addressed to a self wireless equipment from the received data area of the shared Channel corresponding to the transmission time interval.

Objects and advantages of the disclosures will be realized and attained by means of the elements and combinations particularly pointed out in the claims.

### BRIEF DESCRIPTION OF THE DRAWINGS

FIG. 1 is a diagram illustrating a structure of transmission unit data corresponding to a transmission time interval;

FIG. 2 is a diagram of a segment example of segmenting a data area of a data Channel of data decoded by a wireless equipment by a segment count “2”;

FIG. 3 is a diagram of a segment example of segmenting a data area of a data Channel of data decoded by a wireless equipment by a segment count “4”;

FIG. 4 is a diagram illustrating system architecture of a base station;

FIG. 5 is a diagram illustrating system architecture of a wireless equipment;

FIG. 6 is a diagram illustrating a communication sequence chart of the communication system;

FIG. 7 is a diagram illustrating a procedure of RRC signaling;

FIG. 8 is a flowchart illustrating a data transmission procedure to the wireless equipment, the procedure being carried out by the base station;

FIG. 9 is a flowchart illustrating a reception procedure by the wireless equipment;

FIG. 10 is a chart illustrating a communication sequence of the communication system in Example 2;

FIG. 11 is a flowchart illustrating a data transmission procedure to the wireless equipment, the procedure being carried out by the base station in Example 2;

FIG. 12 is a flowchart illustrating a reception procedure by the wireless equipment in Example 2;

FIG. 13 is a diagram illustrating system architecture of the base station in Example 3;

FIG. 14 is a diagram illustrating system architecture of the wireless equipment in Example 3;

FIG. 15 is a diagram illustrating a sequence chart of the communication system in Example 3;

FIG. 16 is a diagram illustrating a modified example of definitions of segment counts;

FIG. 17A is a diagram illustrating a resource allocation method of an uplink response signal;

FIG. 17B is a diagram illustrating a data area of a downlink for indicating the resource allocation method of the uplink response signal; and

FIG. 17C is a diagram illustrating the data area of the downlink for indicating the resource allocation method of the uplink response signal.

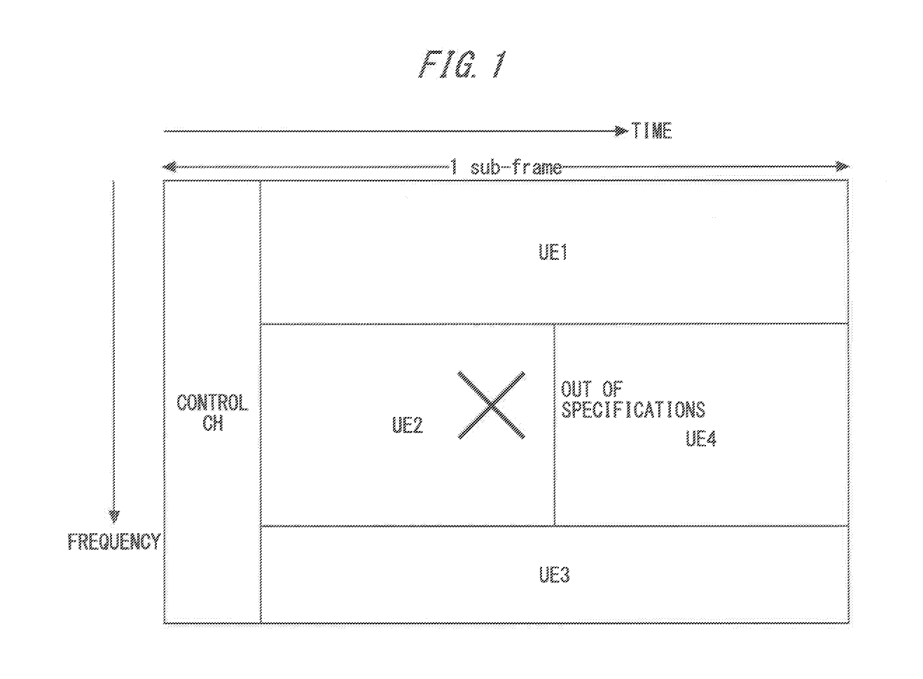

### DESCRIPTION OF EMBODIMENTS

A communication system will hereinafter be described by way of one aspect of an embodiment. The following embodiment is, however, one example, and it does not mean that the communication system is limited to the following embodiment. Note that the following embodiment will be discussed by exemplifying a communication system configured to change part of LTE (Long Term Evolution) Communication Standards proposed in 3GPP (Third Generation Partnership Project) or a communication system to which new architecture is added. However, the embodiment exemplifies one aspect, and it does not mean that the communication system is limited to specifications of #GPP, e.g., LTE and other equivalent specifications.

### Example 1

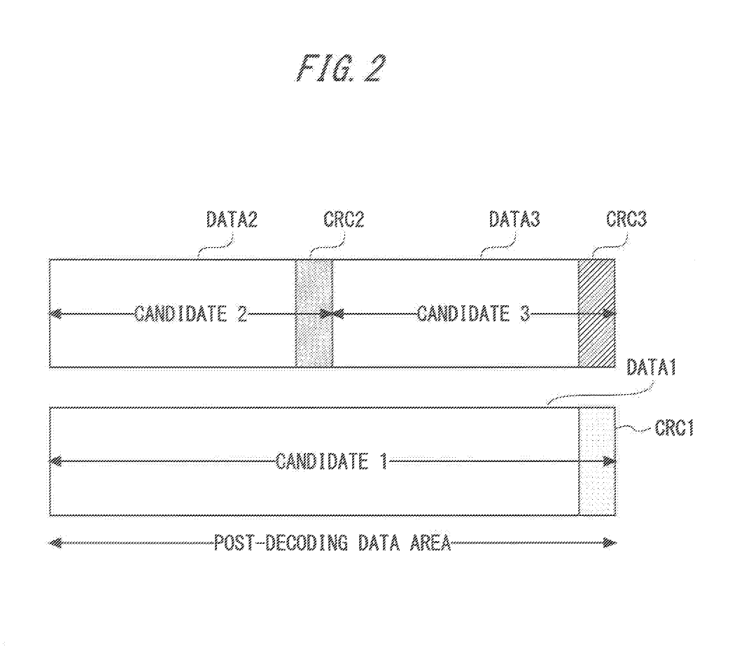

A communication system according to Example 1 will hereinafter be described with reference to drawings in FIGS. 2 through 9.

### [Configuration of Data Channel]

Exemplified at first is a configuration of a data area of a data Channel for transferring and receiving data within a transmission time interval between a base station and a wireless equipment in the communication system according to Example 1. FIG. 2 schematically illustrates the data area of the data Channel of the data decoded by the wireless equipment. The data area in FIG. 2 may also be said to be a data area corresponding to the transmission time interval of a shared Channel to be time-multiplexed on a transmission time interval basis between the base station and a plurality of wireless equipments. PDSCH (Physical Downlink Shared Channel) encompassed by the LTE Standards may be exemplified as one example of the shared Channel. Note that segment frames into which to segment one frame by the transmission time interval are also called “sub-frames”.

FIG. 2 illustrates the data area of the data Channel of the data decoded within the sub-frames. In the data area of FIG. 2, three candidates are instanced as a way of segmenting the data area. A candidate 1 is an example that the data addressed to a single wireless equipment is contained in the data area depicted in FIG. 2. To be specific, in the case of the candidate 1, the data area contains data of DATA1 and a redundant bit of CRC1. The redundant bit of CRC1 is scrambled by a terminal identifier (hereinafter abbreviated to “ID”) of a destination wireless equipment. The terminal identifier (ID) of the wireless equipment is one example of an “identifier unique to the wireless equipment”. Accordingly, the destination wireless equipment descrambles the redundant bit of CRC1 by the self ID, and may, when any error is not detected in DATA1, determine that DATA1 addressed to the self equipment is already decoded.

A candidate 2 and a candidate 3 are given as one example that data addressed to different wireless equipments are contained in data segment areas into which the data area having the same length as the candidate has is segmented by 2. The data segment areas of the candidate 2 and the candidate 3 contain data (DATA2, DATA3) and redundant bits (CRC2, CRC3). CRC2 and CRC3 are scrambled by, e.g., the ID of the destination wireless equipment.

The data segment areas of the candidates 2 and 3 contain the data addressed to the different wireless equipments, in which case the base station previously notifies the wireless equipments of a segment count. The base station may previously notify the wireless equipments of the segment count as triggered by, e.g., transmitting transmission unit data each time or triggered by each call setting between the respective wireless equipments.

When notified of, e.g., “Segment Count=2”, the wireless equipment executes a process in the case of “Segment Count=2” for the data segment area of the received data in addition to executing a process in the case of “Segment Count=1” as in the candidate 1. In the process in the case of “Segment Count=2”, the wireless equipment performs an error detection about DATA2 by descrambling CRC2. When DATA2 is acquired with no error, the wireless equipment determines that DATA2 is addressed to the self equipment. Similarly, the wireless equipment performs the error detection about DATA3 by descrambling CRC3. When DATA3 is acquired with no error, the wireless equipment determines that DATA3 is addressed to the self equipment.

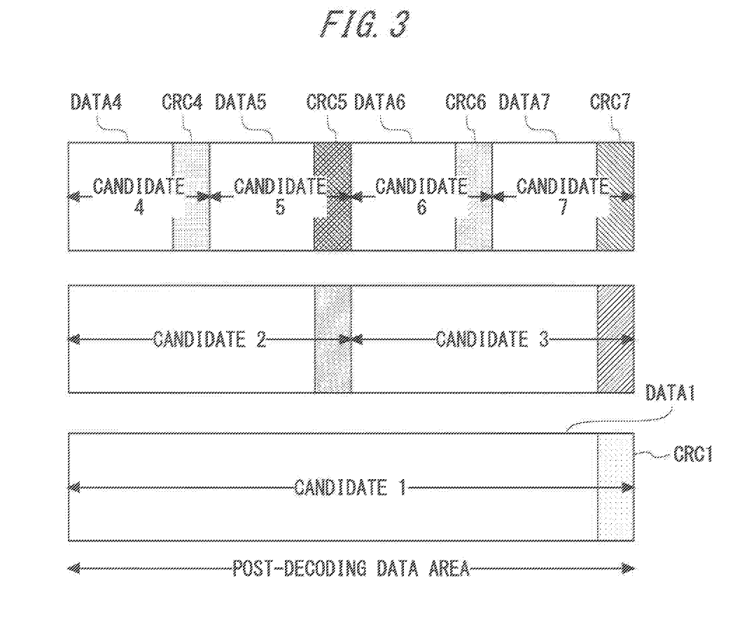

FIG. 3 is an example that the data area is segment by a segment count “4”. Specifically, FIG. 3 depicts three post-decoding data areas of the candidate 1 through a candidate 7. Of these candidates, the candidate 1 through the candidate 3 are the same as those in FIG. 2. The candidate 4 through the candidate 7 are given as an example that the data addressed to the different wireless equipments are contained in data segment areas into which the data area having the same length as the length of the candidate 1 is segmented by 4. The data segment areas of the candidate 4 through the candidate 7 contain the data (DATA 4 through DATA7) and the redundant bits (CRC4 through CRC7). A relationship between the data (DATA 4 through DATA7) and the redundant bits (CRC4 through CRC7) is the same as in the case of FIG. 2.

As in FIG. 3, when the post-decoding data area is segmented by 4, the base station previously notifies the wireless equipments of “Segment Count=4”. The way of notifying of the segment count is the same as the way described in FIG. 2.

The wireless equipment, when notified of “Segment Count=4”, executes a process in the case of “Segment Count=4” for the data segment areas of the received data in addition to executing the process about the candidate 1 in the case of “Segment Count=1” as in the candidate 1 and the process about the candidates 2, 3 in the case of “Segment Count=2.” In the process in the case of “Segment Count=4”, the wireless equipment descrambles the redundant bits by the ID of the self equipment with respect to the segmented data (DATA4 through DATA7) and the redundant bits (CRC4 through CRC7), thus executing a data error detection process with respect to the candidate 4 through the candidate 7. When the data (DATAi, where i=4 through 7) are acquired without any error, the wireless equipment determines that the data are addressed to the self equipment.

Thus, according to Example 1, the wireless equipment, when the base station previously notifies the wireless equipment of “Segment Count=4”, detects the data error, based on a result of scrambling the redundant bits by the ID of the self equipment with respect to the candidates 1 in the case of “Segment Count=1”, the candidates 2, 3 in the case of “Segment Count=2”, and the candidates 1 through 7 in the case of “Segment Count=4”. When DATAi (i=4 through 7) are acquired without any error, the wireless equipment determines that DATAi (i=4 through 7) are addressed to the self equipment.

As in FIGS. 2 and 3, in the communication system according to Example 1, the base station notifies the wireless equipments of the segment count beforehand, and each wireless equipment determines by using the ID of the self equipment which wireless equipment the received data in the segment area is addressed to. Accordingly, e.g., any information representing a relation between a data arrangement in the transmission unit data and the wireless equipment is not needed.

Therefore, according to the configuration of the data area in FIG. 2, the plurality of wireless equipments, after restraining a quantity of control data containing the information representing the relation between the data arrangement in the data area of the decoded data and the wireless equipments, segments the transmission unit data into the plurality of segment data, and is thereby enabled to perform the communications based on the multiplexing of the wireless equipments. The data (DATAi) are arranged in the segment areas corresponding to the segment count, and the redundant bits (CRCi) are descrambled by the ID of each wireless equipment. The wireless equipment determines, based on whether an error of the data (DATAi) is detected, whether the data in the segment area is addressed to the self equipment. Therefore, as compared with the method of predetermining the data arrangement in the communication unit data and notifying the information about the data arrangement to the wireless equipment from the base station, the communications of the method illustrated in FIGS. 2 and 3 have no decrease in flexibility of the data arrangement. The segment count is one example of a “segment designated value”.

FIGS. 2 and 3 illustrate the process of scrambling the redundant bits (CRC1 and other equivalent bits) by the ID of the wireless equipment, and transmitting the data to the wireless equipment from the base station. It does not, however, mean that the configuration of the communication system is limited to this process. For instance, a predetermined field, e.g., data, other than the redundant bit may be scrambled by the ID of the wireless equipment and transmitted to the wireless equipment from the base station. Both of the data in the segment area and the redundant bit may be scrambled by the ID of the wireless equipment and transmitted to the wireless equipment from the base station. In other words, the base station may simply scramble the segment area or the predetermined field of the segment area addressed to the destination wireless equipment by the ID of the destination wireless equipment. It may be sufficient that the wireless equipment descrambles the segment area or the predetermined field of the segment area in the data area by the ID of the self wireless equipment, and determines whether the area is the segment area containing the data addressed to the self wireless equipment.

Incidentally, it does not mean that the self wireless equipment ID used for descrambling has a particular limitation. The ID may be, e.g., a connection identifier or a connection indicator. Further, the ID may also be C-RNTI (Cell Radio Network Temporary Identifier).

[System Architecture]

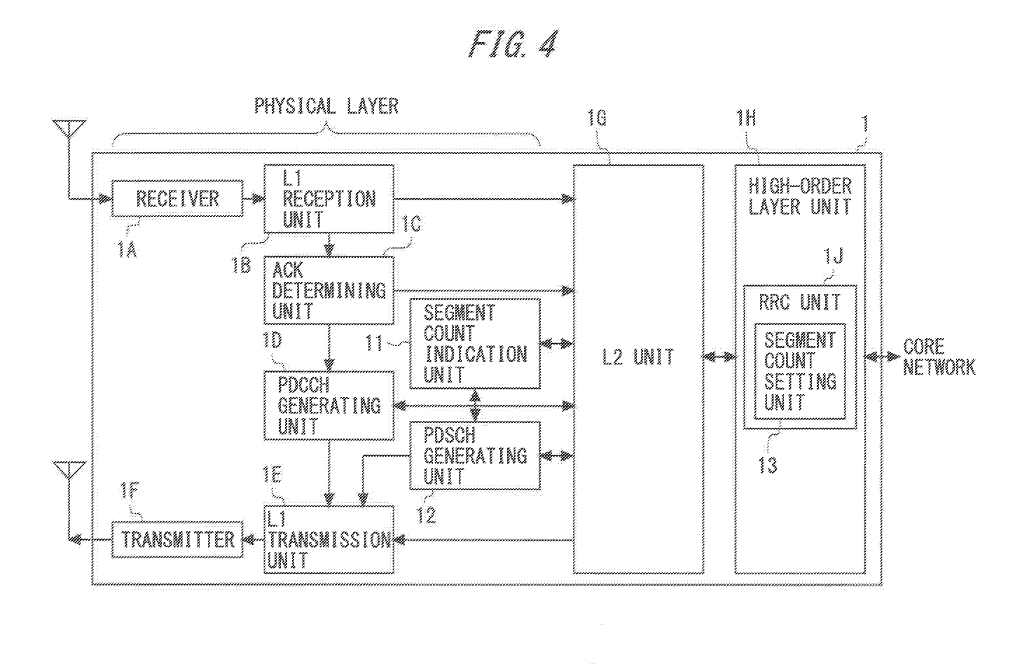

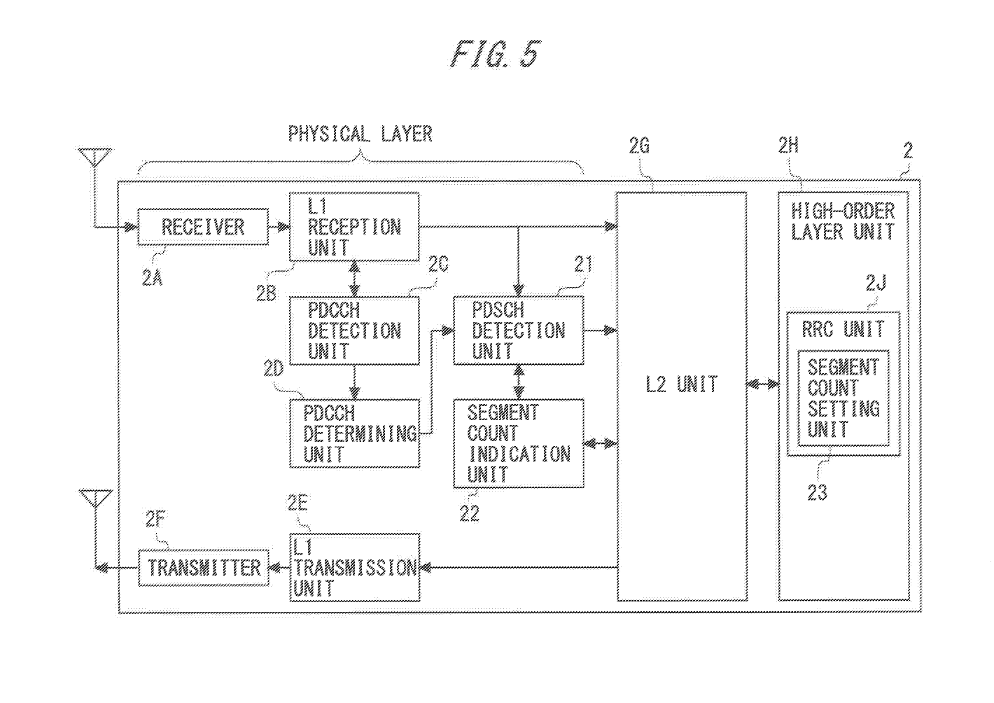

Architecture of the communication system will be described in FIGS. 4 and 5. FIG. 4 illustrates the system architecture of a base station 1. The base station 1 includes a high-order layer unit 1H, an L2 unit 1G and components of a physical layer. The base station 1 includes, as the components of the physical layer, a receiver 1A, an L1 reception unit 1B, an ACK determining unit 1C, a PDCCH (Physical Downlink Control Channel) generating unit 1D, an L1 transmission unit 1E, a transmitter 1F, a segment count indication unit 11 and a PDSCH generating unit 12. The high-order layer unit 1H includes a RRC (Radio Resource Control) unit 1J, and the RRC unit 1J includes a segment count setting unit 13.

Of these components, e.g., the high-order layer unit 1H, the L2 unit 1G, the L1 reception unit 1B, the ACK determining unit 1C, the PDCCH generating unit 1D, the L1 transmission unit 1E, the RRC unit 1J, the segment count indication unit 11, the PDSCH generating unit 12 and the segment count setting unit 13, may be hardware circuits and may also be components including a DSP (Digital Signal Processor), a CPU (Central Processing Unit) and other equivalent processors, firmware and computer programs and other equivalent software on a memory.

The high-order layer unit 1H functions as an interface between a core network and the L2 unit 1G. For example, the high-order layer unit 1H receives a packet addressed to the wireless equipment from the core network, and hands over the packet to the L2 unit 1G. As in FIG. 4, according to Example 1, the high-order layer unit 1H includes the RRC unit 1J executing RRC (Radio Resource Control) signaling. The RRC unit 1J establishes a connection between the base station 1 and a wireless equipment 2 via the L2 unit 1G, the L1 transmission unit 1E and the L1 reception unit 1B. The RRC unit 1J, when establishing the connection with the wireless equipment 2, notifies the wireless equipment of the segment count of the data area of the data transmitted and received via a data Channel in the sub-frame. The segment count setting unit 13 of the RRC unit 1J sets the segment count notified to the wireless equipment 2 in the segment count indication unit 11 on a low-order layer. The segment count setting unit 13 is one example of a “segment notifying unit”. The segment count is one example of a “segment designated value”.

The L2 unit 1G functions as an interface with the high-order layer unit 1H in cooperation with the L1 reception unit 1B, the ACK determining unit 1C, the PDCCH generating unit 1D, the L1 transmission unit 1E, the segment count indication unit 11 and the PDSCH generating unit 12.

For example, the L2 unit 1G acquires the data, addressed to the wireless equipment, of a high-order layer from the high-order layer unit 1H, and hands over the data to the PDSCH generating unit 12 on the physical layer. Hereat, the L2 unit 1G segments the packet defined as a data transfer unit of the high-order layer into predetermined blocks. The L2 unit 1G hands over the blocks to the PDSCH generating unit 12 on the low-order layer. A transport block based on the 3GPP specifications may be exemplified as one example of the predetermined block.

Note that the L2 unit 1G transmits various items of broadcast data given from the high-order layer to the wireless equipment 2 via the L1 transmission unit 1E in addition to segmenting the packet of the high-order layer into the predetermined blocks and handing over the blocks to the PDSCH generating unit 12. The L2 unit 1G acquires uplink data from data demodulated by the L1 reception unit 1B, and hands over the uplink data to the high-order layer unit 1H.

The receiver LA is, e.g., an electronic circuit amplifying a high frequency signal, and performing an analog/digital conversion and other equivalent operations. The receiver 1A converts a signal received from an antenna into a digital signal, and hands over the digital signal to the L1 reception unit 1B.

Note that the antenna may serve both as a reception antenna and as a transmission antenna, and different antennas may also be available. In FIG. 4, though omitted, the base station 1 may be configured to perform MIMO (Multi-Input Multi-Output) transmission/reception to communicate with the wireless equipment 2 by combining a plurality of antennas, the receiver 1A and the transmitter 1F. The L1 reception unit 1B acquires data of a control Channel or a data Channel by executing digital demodulation, decoding, the CRC based error detection and other equivalent operations, and hands over the acquired data to the L2 unit 1G.

The ACK (acknowledgement) determining unit 1C monitors an ACK bit for retransmission in the data that is digital-demodulated and decoded by the L1 reception unit 1B. To be specific, the wireless equipment 2, upon receiving the data from the base station 1, decodes the data and, as a result, transmits the acknowledgment indicating whether the data is correctly received to the base station 1. The ACK determining unit 1C monitors the ACK on a physical Channel, and reports a monitoring result to the L2 unit 1G. When the retransmission is carried out, the ACK determining unit 1C notifies the wireless equipment 2 that the retransmission is to be carried out and of a retransmission schedule thereof via the PDCCH generating unit 1D.

The PDCCH generating unit 1D generates data of a physical downlink control Channel. The physical downlink control Channel indicates downlink scheduling including allocation of resources, a transmission format and other equivalent items of the PDSCH, i.e., the physical downlink shared Channel, while the physical uplink control Channel indicates uplink scheduling including allocation of resources, a transmission format and other equivalent items of the PUSCH, i.e., the physical uplink shared Channel.

The segment count indication unit 11 receives the segment count of the data area in the sub-frame from the high-order layer unit 1H, and retains this segment count. The segment count indication unit 11 indicates the segment count of the data area in the sub-frame to the PDSCH generating unit 12.

The PDSCH generating unit 12 acquires user data addressed to the wireless equipment 2 from the L2 unit 1G, and sets the user data in the sub-frame. The PDSCH generating unit 12 is one example of a “segment data setting unit”. In Example 1, the PDSCH generating unit 12 segments the data area in the sub-frame according to the indicated segment count, sets the user data and maps the user data to a resource specified by a frequency of the physical downlink shared Channel and the time, thereby generating the sub-frame. The user data are managed, e.g., in the predetermined blocks. Example 1 is based on an assumption that a data quantity of the predetermined block is smaller than a data quantity of the data area within the transmission time interval, i.e., within the sub-frame.

In Example 1, the PDSCH generating unit 12 sets the data addressed to the wireless equipment 2 in the segment areas into which to segment the data area in the sub-frame, and sets a CRC (Cyclic Redundancy Check) code descrambled by the ID of the destination wireless equipment to ending of the segment area. Accordingly, the destination wireless equipment 2 acquires the data with no error from the segment area in the sub-frame by descrambling the CRC code by the ID of the self wireless equipment, and is thereby enabled to recognize that the data in this segment area is addressed to the self equipment.

The L1 transmission unit 1E encodes the sub-frame generated by the PDSCH generating unit 12 to perform the digital modulation, and transmits radio signals from the antenna via the transmitter 1F. The transmitter 1F is an electronic circuit that performs, e.g., the digital/analog conversion, amplifying the high frequency signal, and other equivalent operations. The transmitter 1F generates an analog high frequency signal from the transmission digital signal coming from the L1 transmission unit 1E, and transmits the signal from the antenna.

FIG. 5 depicts system architecture of the wireless equipment 2. The wireless equipment 2 has a high-order layer unit 2H, an L2 unit 2G, and components of the physical layer.

The wireless equipment 2 includes, as the components of the physical layer, a receiver 2A, an L1 reception unit 2B, a PDCCH detection unit 2C, a PDCCH determining unit 2D, an L1 transmission unit 2E, a transmitter 2F, a PDSCH detection unit 21, and a segment count indication unit 22. The high-order layer unit 2H includes an RRC unit 2J, and the RRC unit 2J includes a segment count setting unit 23. Of these components, e.g., the L1 reception unit 2B, the PDCCH detection unit 2C, the PDCCH determining unit 2D, the L1 transmission unit 2E, the segment count indication unit 22, the L2 unit 2G, the high-order layer unit 2H, the RRC unit 2J and the segment count setting unit 23 may be the hardware circuits, and may also be components including the DSP (Digital Signal Processor), a CPU (Central Processing Unit) and other equivalent processors, the firmware and the computer programs and other equivalent software on the memory.

Configurations and operations of the receiver 2A and the transmitter 2F are the same as those of the receiver 1A and the transmitter 1B of the base station 1. The L1 reception unit 2B acquires the data in the sub-frame by executing the digital demodulation, the decoding, the CRC based error detection and other equivalent operations with respect to the sub-frame acquired from the receiver 2A. The L1 reception unit 2B hands the broadcast information of the data in the sub-frame from the base station 1 over to the L2 unit 2G. The broadcast information contains, e.g., the data and other equivalent information broadcasted from the base station 1. On the other hand, the L1 reception unit 2B hands over the control Channel (PDCCH) and the data Channel (PDSCH) of the data in the sub-frame to the PDCCH detection unit 21.

The PDCCH detection unit 2C determines whether the data handed over from the L1 reception unit 2B contains control data addressed to the self equipment. It may be determined from, e.g., the ID of the self equipment whether the data is the control data addressed to the self equipment. The PDCCH detection unit 2C hands over the control data addressed to the self equipment and the information of the data area to the PDCCH determining unit 2D. The PDCCH determining unit 2D acquires schedule information instanced by allocation of the sub-frames and other equivalent items from the control data addressed to the self equipment. The PDCCH determining unit 2D hands over the data area in the sub-frame allocated based on the schedule information to the PDSCH detection unit 21.

The PDSCH detection unit 21 determines based on the segment count indicated by the segment count indication unit 22 whether the segment area obtained by segmenting the data area in the sub-frame is a segment area addressed to the self equipment. The PDSCH detection unit 21 is one example of a “self equipment data acquiring unit”.

When designated to segment the data area by “2”, the PDSCH detection unit 21 detects the data error from the CRC code scrambled by the ID of the self equipment with respect to the segment areas of the candidates 1 through 3 in FIG. 2. When further designated to segment the data area by “4”, the PDSCH detection unit 21 detects the data error from the CRC code scrambled by the ID of the self equipment with respect to the segment areas of the candidates 1 through 7 in FIG. 3. The PDSCH detection unit 21 determines as a result of the CRC that the data of the segment area with any error being detected is the data addressed to the self equipment.

The L2 unit 2G functions as an interface with the high-order layer unit 2H in cooperation with the L1 reception unit 2B, the PDSCH detection unit 21, the segment count indication unit 22 and the L1 transmission unit 2E. For example, the L2 unit 2G acquires various items of information instanced by the broadcasted information from the base station 1 via the L1 reception unit 2B, and hands over the acquired information to the high-order layer unit 2H. The L2 unit 2G hands over the segment count acquired by the RRC unit 2J of the high-order layer unit 2H to the segment count indication unit 22.

The L2 unit 2G transmits, to the base station 1 via the L1 transmission unit 2E, a detection result of the segment area detected by the PDSCH detection unit 21 as the acknowledgment. This acknowledgement is called a hybrid ARQ (Automatic Retransmission Request) according to, e.g., 3GPP.

The communication system in Example 1 may simply use the normal hybrid ARQ intact with no setting of the segment areas in the data area. The wireless equipment 2 transmits the acknowledgement on the predetermined block basis instanced by the transport block and other equivalent blocks back to the base station 1 via the uplink set between the self equipment and the base station 1. The base station 1 retains the arrangement of the segment areas in the sub-frames already transmitted to the wireless equipments 2 and the information of the destination wireless equipments 2 of the data set in the segment areas.

For example, it is presumed that one sub-frame contains one or more segment areas addressed to the wireless equipments 2-1, 2-2. When disabled from receiving the acknowledgement on the transport block basis from the wireless equipment 2-1, it may be sufficient that the base station 1 targets the transport block for the retransmission. In other words, it may be sufficient that the base station 1 targets again the transport block with none of the acknowledgement being obtained for the transmission, and notifies the wireless equipment 2 of the resource allocation via the PDCCH generating unit 1D. It may be also sufficient that the base station 1 causes the PDSCH generating unit 12 to map again the data to the segment areas, and retransmits the data from the downlink via the L1 transmission unit 1E and the transmitter 1F. Hence, the communication system in Example 1 assumes that the block instanced by the transport block to be transmitted to the wireless equipment 2 from the base station 1 via the downlink is smaller than the data area in the sub-frame. However, a retransmission control procedure may also be carried out according to standards of hybrid ARQ proposed by 3GPP and other equivalent acknowledgements.

As in FIG. 5, in Example 1, the high-order layer unit 2H includes the RRC unit 2J to execute the RRC signaling. The RRC unit 2J establishes the connection between the base station 1 and the wireless equipment 2 via the L2 unit 2G, the L1 transmission unit 2E and the L1 reception unit 2B. The RRC unit 2J receives the segment count of the data area in the sub-frame from the base station when establishing the connection with the base station 1. The RRC unit 2J hands over the segment count to the segment count setting unit 23. The segment count setting unit 23 sets the received segment count in the segment count indication unit 22 on the physical layer. The high-order layer unit 2H hands over the data handed over from the L2 unit 2G to an application.

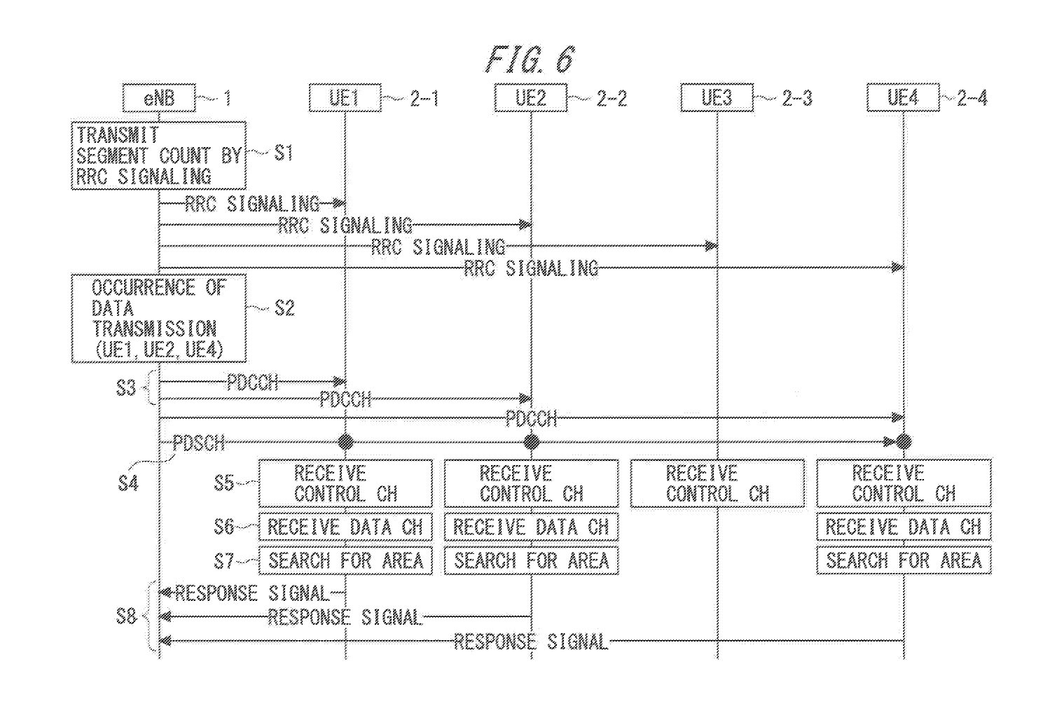

FIG. 6 illustrates a communication sequence of the communication system. FIG. 6 depicts the base station 1 (generally notated by eNB or eNodeB) and the wireless equipments 2-1 through 2-4 (UE1 through UE4). Note that the wireless equipment 2 is a generic term when the wireless equipments 2-1 through 2-4 are collectively referred to.

Example 1 is based on a premise that before transmitting the data, the RRC signaling is carried out, and the connection between the base station 1 and the wireless equipment 2 is established (S1). The RRC signaling involves having a random access to the base station 1 from the wireless equipment 2. In Example 1, in the RRC signaling, the base station 1 notifies the wireless equipment 2 of the segment count. The segment count setting unit 13 of the RRC unit 1J executing the process in S1 is one example of a “segment notifying unit”. The process in S1 is one example of a “process of notifying a segment designated value to a wireless equipment as triggered by each call setting”.

FIG. 7 illustrates an RRC signaling procedure. The RRC signaling is conducted during a connection setting process called the random access. The random access involves establishing synchronization between the wireless equipment 2 and the base station 1 in response to, e.g., a request of the wireless equipment 2. After establishing the synchronization, and the RRC signaling is carried out between the wireless equipment 2 and the base station 1, thereby checking the ID for uniquely identifying the wireless equipment 2. Note that the ID may be any element uniquely possessed by the wireless equipment 2 and may also be any element uniquely determined by the base station 1 in response to the request of the wireless equipment 2.

Further, the wireless equipment 2 makes a setting request for wireless communications (RRCConnectionRequest). The base station 1 notifies the wireless equipment 2 of setting information for the wireless communications (RRCConnectionSetup). For example, the wireless equipment 2 is notified of the segment count of the data area, the resource information for the uplink, and other equivalent information. when the wireless equipment 2 normally finishes the setting based on the setting information, the base station 1 is notified of this purport (RRCConnectionSetupComplete). The base station 1 notifies of the segment count by RRC and is thereby enabled to notify the wireless equipment 2 of the segment count by which to segment the data area or of a border position between the segment areas.

In FIG. 6, the data to be transmitted to the wireless equipment 2 occurs on the side of the base station 1 (S2). The base station 1 transmits the data to the wireless equipment 2 by designating the allocation of the resources of, e.g., the physical downlink shared Channel (PDSCH) in the sub-frame in the control Channel (e.g., PDSCH) on the sub-frame.

As described above, the radio resource may be considered to be the data area segmented by the frequency (subcarrier) transmitted and received at the transmission time interval and the time. The sub-frame has 14 symbols for one subcarrier. Of the 14 symbols, a plurality of symbols counted from the beginning, i.e., “1” is transmitted as the control Channel (S3). The symbols, exclusive of the symbols used for the control Channel, of the 14 symbols are for user data and transmitted as the data of, e.g., the physical downlink shared Channel (PDSCH) (S4). Note that as illustrated in FIGS. 2 and 3, in Example 1, the data area in the subfield is segmented for every plurality of wireless equipments 2.

Then, e.g., the wireless equipment 2-1 determines whether or not the ID designated in the control Channel is addressed to the self equipment. For example, the control data and the CRC code are designated in the data of the control Channel. The CRC is descrambled by the ID. Accordingly, the wireless equipment 2-1 descrambles the CRC by the ID of the self equipment, then recognizes that the data is the data of the control Channel addressed to the self equipment when any error is not detected from the control data, and receives the data of the control Channel (S5).

Next, the wireless equipment 2-1 receives the data of the physical downlink shared Channel (PDSCH), which is designated in the control Channel received in S5 (S6). The wireless equipment 2-1 executes an area search according to the segment count acquired when performing the RRC signaling (S7). The area search connotes conducting the CRC based error detection with respect to the candidates of the respective segment areas as illustrated in FIGS. 2 and 3. The PDSCH detection unit 21 executing the process in S7 is one example of a “self equipment data acquiring unit”.

In Example 1, e.g., the wireless equipment 2 uses the CRC code for the error detection by descrambling the CRC code with the ID of the self equipment. As a result of the error detection, when the segment area with any error not being detected exists in any one of the segment areas, the wireless equipment 2 recognizes the segment area with the error not being detected as the segment area of the data addressed to the self equipment. The wireless equipment 2-1 transmits a response signal back to the base station 1 (S8).

In the example of FIG. 6, the wireless equipment 2-2 and the wireless equipment 2-4 perform the area search in the same procedure as the procedure of the wireless equipment 2-1, and transmit the response signals back to the base station 1 (S8). On the other hand, the wireless equipment 2-3 detects none of the control Channel addressed to the self equipment when receiving the control Channel (S9), and therefore does not reach the reception of the data Channel in an as-is status.

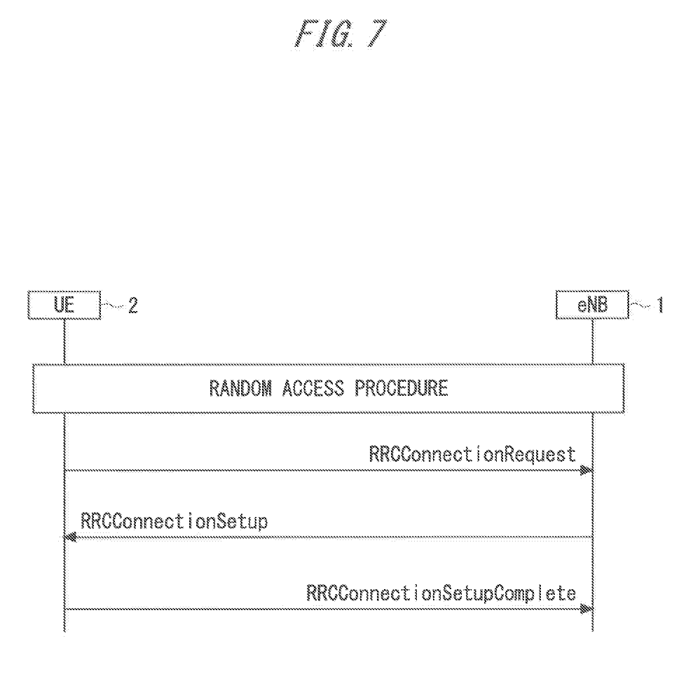

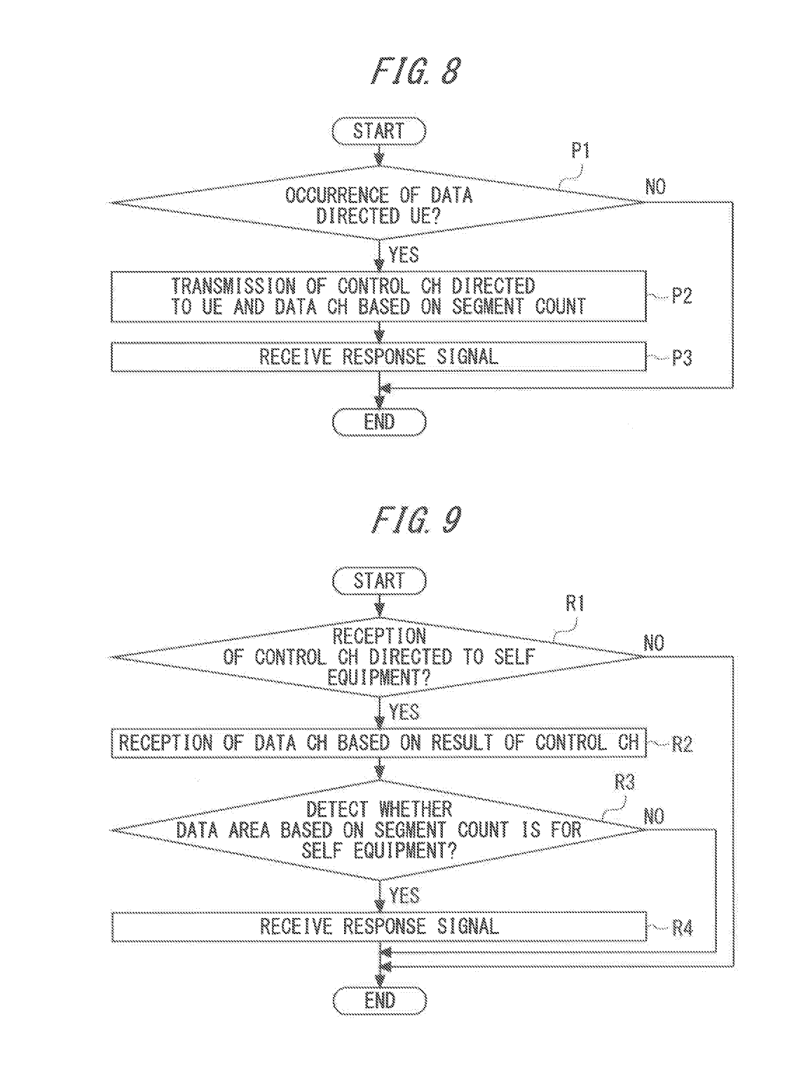

FIG. 8 illustrates a data transmission procedure to be executed by the base station 1 and directed to the wireless equipment 2. A processor of the base station 1 may also be configured to execute the processes in FIG. 8 according to a computer program deployed in an executable manner on a main storage. However, the base station 1 may also be configured to execute anyone or the whole of the processes in FIG. 8 by a dedicated digital circuit.

The base station 1 at first determines whether the data directed to the wireless equipment 2 occurs (P1). The data directed to the wireless equipment (UE) 2 occurs upon running an application program contained in, e.g., the high-order layer unit 1H in FIG. 4. When the data directed to the wireless equipment 2 (“Y” in P1), the base station 1 sets the data (e.g., the transport block) directed to the wireless equipment 2 in the data Channel, based on the designation of the resource and the segment count in the control Channel directed to the wireless equipment 2, and transmits the data to the wireless equipment 2 (P2). The PDSCH generating unit 12 executing the process in P2 is one example of a “segment data setting unit”.

The following is a detailed instance of the process in P2. As already described, the base station 1 previously notifies each wireless equipment 2 of the segment count by the RRC signaling and other equivalent techniques. As explained in FIG. 4, the segment count indication unit 11 of the base station 1 retains the segment count. The PDSCH generating unit 12 of the base station 1 arranges the data directed to the wireless equipment 2 in the segment area obtained by segmenting the data area transmitted via the data Channel (PDSCH), based on the segment count retained by the segment count indication unit 11. The PDSCH generating unit 12 descrambles the CRC code of the data directed to the wireless equipment 2 receiving the data arrangement by the ID of the wireless equipment 2, and arranges the descrambled CRC code at the tail of the segment area.

The L1 transmission unit 1E of the base station 1 transmits control Channel (PDCCH) data containing the allocation information of the resource blocks of the data Channel (PDSCH) and the allocation information of the Channel of the uplink response signal, and the data Channel (PDSCH) data. As described above, in Example 1, the base station 1 may segment, by the segment count, the data area excluding the control data in the subfield to be transmitted at the transmission time interval. Accordingly, even when the data instanced by the transport block directed to the wireless equipment is smaller than the data area in the sub-frame, the base station 1 may transmit the data directed to the wireless equipment to the wireless equipment 2 by reducing a free area to the greatest possible degree.

Note that FIGS. 2 and 3, as already described with reference to FIGS. 2 and 3, illustrate the process of scrambling the redundant bit (CRC1 and other equivalent codes) by the ID of the wireless equipment and transmitting the data to the wireless equipment from the base station. It does not, however, mean that the architecture of the communication system is limited to this process. For example, the predetermined field, e.g., the data, other than the redundant bit may also be scrambled by the ID of the wireless equipment and transmitted to the wireless equipment from the base station. Both of the data in the segment area and the redundant bit may also be scrambled by the ID of the wireless equipment and transmitted to the wireless equipment from the base station. In other words, it may be sufficient that the base station simply scramble the segment area or the predetermined field of the segment area addressed to the destination wireless equipment by the ID unique to the destination wireless equipment.

As illustrated in FIGS. 2 and 3, it may also be sufficient that the base station 1 sets the segment areas by using the segment count as a maximum segment count. For instance, the data size addressed to the wireless equipment 2 is larger than a data capacity of the segment area obtained by equally segmenting the data area by the segment count, in which case it may be sufficient that the data area is segmented by a count smaller than the segment count so that the data size addressed to the wireless equipment 2 becomes a receivable data capacity, thus setting the data addressed to the wireless equipment 2. As discussed above, the PDSCH generating unit 12 of the base station 1 executes, as one example of a “segment data setting unit”, the process in P2.

Next, the base station 1 monitors the Channel of an uplink response signal and receives the response signal, the Channel being allocated to the wireless equipment 2 in the process of P2 (P3). Note that the base station 1, when unable to acquire the acknowledgement about the data directed to the wireless equipment 2 and transmitted in P2 from the response signal in P3, may simply retransmit the data by executing again the processes in P2, P3. In this case, the base station 1 may simply retransmit the data of the control Channel (PDCCH) and the data of the data Channel (PDSCH) afresh.

FIG. 9 depicts a reception procedure of the wireless equipment 2. A processor of the wireless equipment 2 may also be configured to execute the processes in FIG. 8 according to the computer program deployed in the executable manner on the main storage. However, any one or the whole of the processes in FIG. 8 may also be executed by the dedicated digital circuit.

To begin with, the PDCCH detection unit 2C of the wireless equipment 2 receives the data of the control Channel (PDCCH) directed to the self equipment (R1). The PDCCH detection unit 2C may simply detect the data of the control Channel (PDCCH) directed to the self equipment by determining whether the data of the control Channel contains the ID of the self equipment. For instance, the PDCCH detection unit 2C performs the error detection by scrambling the CRC code of the received data of the control Channel (PDCCH) by the ID of the self equipment, and may thus detect the data of the control Channel (PDCCH) directed to the self equipment.

Upon receiving the data of the control Channel directed to the self equipment (“Y” in R1), the PDCCH determining unit 2D of the wireless equipment 2 acquires the allocation and other equivalent items of the data Channel (PDSCH) designated by the data of the control Channel. The PDSCH detection unit 21 of the wireless equipment 2 receives the data of the data Channel (PDSCH), based on the designation of the data of the control Channel (R2).

Further, the PDSCH detection unit 21 of the wireless equipment 2 previously searches for the data area of the received data Channel (PDSCH), based on the set segment count from the base station 1. As a result of the search based on the segment count, it is detected whether the segment area is addressed to the self equipment (R3). The PDSCH detection unit 21 executing the process in R3 is one example of a “self equipment data acquiring unit”.

It may be sufficient that, e.g., the wireless equipment 2 determines whether the error detection of the segment area indicates a normal result, by disassembling the CRC code at the tail of the segment area by the ID of the self equipment. When the data for the self equipment is detected in the segment area obtained by segmenting the data area by the predetermined segment count, the wireless equipment 2 transmits the response signal to the base station 1 (R4).

Note that the wireless equipment 2 searches for the data area, with the segment count being set as the maximum segment count. In this case, the wireless equipment 2 searches first for an unsegmented data area and, when unable to acquire the data addressed to the self equipment, may search for the data areas by incrementing the segment count up to the maximum segment count on a one-by-one basis like 2, 3, 4. The wireless equipment 2 may also searches for the data areas by decrementing the segment count from the maximum segment count on the one-by-one basis. In other words, the wireless equipment 2, at first, when unable to acquire the data addressed to the self wireless equipment from the segment areas obtained by equally segmenting the data area by the segment count, may also search for the segment areas containing the data addressed to the self wireless equipment from the segment areas obtained by sequentially segmenting the data area by a count smaller than the segment count given above. As described with reference to FIGS. 2 and 3, it may be sufficient that the wireless equipment 2 determines whether the segment area concerned contains the data addressed to the self wireless equipment by descrambling the segment area in the data area or the predetermined field of the segment area by the ID of the self wireless equipment. As described above, the PDSCH detection unit 21 of the wireless equipment 2 executes, as one example of a “self equipment data acquiring unit”, the process in R3.

As discussed above, the communication system in Example 1, the data area exclusive of the control data in the sub-frame, i.e., the data segmented at the transmission time interval, is segmented in a time axis direction. To be specific, the base station 1 previously notifies the wireless equipment 2 of the segment count, and sets the data directed to the wireless equipment 2 by segmenting the data area in the sub-frame (see FIGS. 2 and 3). On the other hand, the wireless equipment 2 searches for the data in the data area in accordance with the segment count, then determines whether the data is addressed to the self equipment, and receives the data addressed to the self equipment.

The communication system in Example 1 enables the wireless equipment 2, when the base station 1 previously notifies the wireless equipment 2 of the segment count, to detect the data addressed to the self equipment from the segmented data areas, based on the ID of the self equipment. Accordingly, when segmenting the data area in the sub-frame into the plurality of segment areas, the base station 1 does need to notify the wireless equipment 2 of the allocation of the segment areas. In other words, according to the communication system in Example 1, the control data used for notifying the wireless equipment 2 of the allocation of the segment areas is restrained from newly increasing due to the segmentation of the sub-frame. The base station 1 is thereby enabled to transmit the data directed to the wireless equipment 2 in a way that reduces the free areas by embedding the data having the data size smaller than the data area of the sub-frame corresponding to the transmission time interval into the segmented data area.

As described with reference to FIGS. 2, 3 and in P2 of FIG. 8 and in R3 of FIG. 9, in the communication system, the base station 1 scrambles the segment area or the predetermined field of the segment area addressed to the destination wireless equipment by the ID of the wireless equipment. Each wireless equipment 2 descrambles the segment area or the predetermined field of the segment area in the received data area by the ID of the self wireless equipment, thereby determining whether the segment area concerned contains the data addressed to the self wireless equipment. Accordingly, the data areas transmitted and received on the sub-frames are possible of being substantially simply multiplexed between the plurality of wireless equipments by using the segment areas each having the data capacity smaller than the sub-frame without notifying the arrangement of the segment areas to the wireless equipments 2 from the base station 1.

As described with reference to FIGS. 2 and 3, the data size addressed to the wireless equipment is larger than the data capacity of the segment area obtained by equally segmenting the data area by the segment count in the process of P2 in FIG. 8, in which case the base station 1 sets the data addressed to the wireless equipment by segmenting the data area by the count smaller than the segment count so that the data addressed to the wireless equipment becomes the receivable data capacity. On the other hand, the wireless equipment 2, when unable to acquire the data addressed to the self wireless equipment from the segment area obtained by equally segmenting the data area by the segment count in the process of R3 in FIG. 9, the wireless equipment 2 searches for the segment area containing the data addressed to the self wireless equipment from the segment area obtained by segmenting the data area by the count smaller than the segment count concerned. Accordingly, the communication system in Example 1 makes flexible the data arrangement in the segment areas and enables the reduction of the free areas in transferring and receiving the variety of data sizes.

[Modified Example of Designating Segment Bit Count]

In Example 1, the base station 1 notifies beforehand the wireless equipment 2 of the segment count N of the post-decoding data area. The wireless equipment 2 presumes the case of the decoded data area with no segmentation up to the segmented-by-N case, and determines whether the data is the data addressed to the self equipment by descrambling the CRC code by the ID of the self equipment.

The base station 1 may notify the wireless equipment 2 of the bit count of the segment area in place of the method of notifying the segment count to the wireless equipment 2 from the base station 1 as described above. This case is exemplified by segmenting a size of the segmented data area by every 25 bits, every 50 bits, every 100 bits, every 200 bits or by every M bits. The base station 1 may notify the wireless equipment 2 of this bit count of the segment area. The bit count of the segment area is one example of a “segment designated value”.

For example, the designated value is predetermined per segment bit count, and the base station 1 may notify the wireless equipment 2 of the designated value. These designated values per segment bit count are instanced by Designated Value “0”:Segment Bit Count “25”, Designated Value “1”:Segment Bit Count “50”, Designated Value “2”:Segment Bit Count “100”, Designated Value “3”:Segment Bit Count “200”, and other equivalent tuples.

The base station 1, when sending the designated values (0 through 3) to the wireless equipment 2, is notified of 2 bits in signaling of notification of the designated value. On the other hand, the base station 1, when notifying the wireless equipment 2 of a specific segment bit count (25, 50, 100, 200), is notified of 8-bit data in signaling of the notification of the designated value. Namely, the bit count when signaling is decreased by using the designated value. The notification of the specific segment bit count enables flexible multiplexing of the wireless equipments 2.

Each of the designated values 0, 1, 2, 3 and other equivalent values for designating the bit count of the segment area is also one example of the “segment designated value”. Note that in the modified example of designating the segment bit count, the segment count setting unit 13 illustrated in FIG. 4 notifies the wireless equipment 2 of the segment bit count or the designated value (0, 1, 2, 3 and other equivalent values). It may be sufficient that the wireless equipment searches for the data area, based on the segment bit count or the designated value.

[Other Modified Examples]

In the embodiment, the base station 1 descrambles the CRC code by the ID of the wireless equipment 2, while the wireless equipment 2 descrambles the CRC code by the ID of the self equipment, thereby determining whether the data is the data addressed to the self equipment. In this case, it does not mean that the process of the communication system is limited to the CRC. In other words, the base station 1 and the wireless equipment 2 may use redundant data instanced by other error correction codes in place of the CRC code.

### Example 2

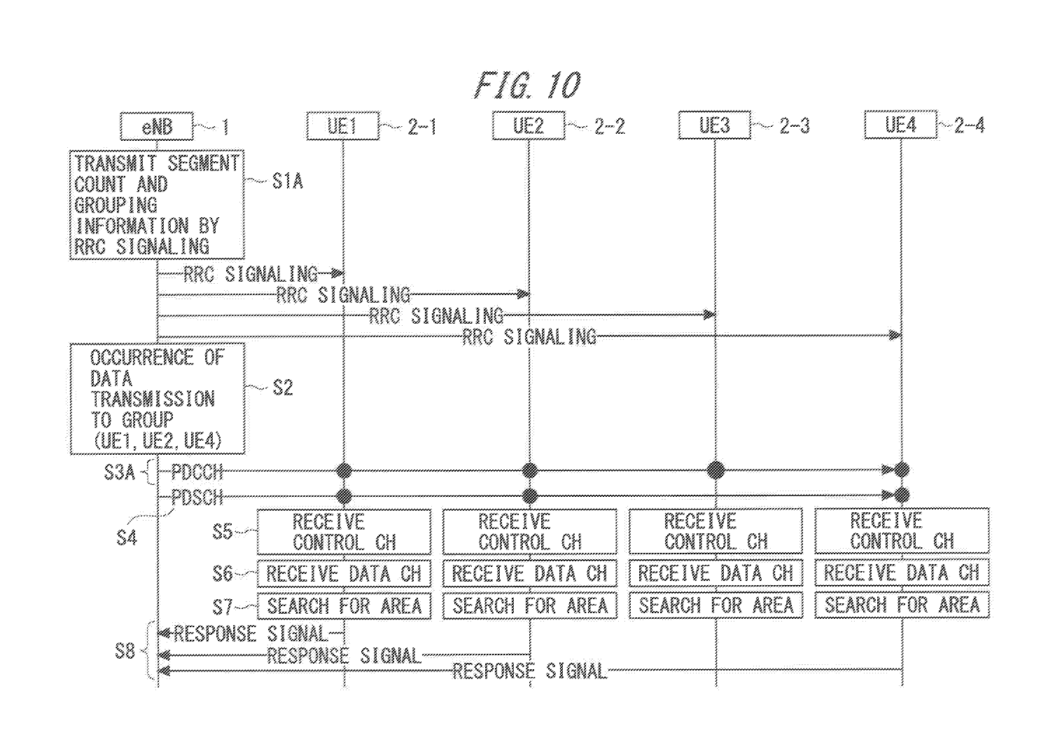

A communication system according to Example 2 will be described with reference to FIGS. 10 through 12. In Example 1, the base station 1 segments the data area in the sub-frame to be transmitted at the transmission time interval, and adds the data addressed to the wireless equipment 2 and the CRC code descrambled by the ID of the wireless equipment 2 to the segment area. The wireless equipment 2 descrambles the CRC code at the tail of the segment area by the ID of the self equipment, and determines whether the data addressed to the self equipment exists, based on the result of whether the error detection of the data in the segment area is normally finished. In Example 1, the base station 1 transmits the control data (PDCCH) individually to every wireless equipment 2.

In Example 2, the plurality of wireless equipments 2 is grouped, and a group ID is distributed beforehand to each wireless equipment 2. The base station 1 distributes the control data (PDCCH) in a way that allocates the group ID to the control data (PDCCH). For example, the base station 1 descrambles the CRC code to be transmitted together with the control data (PDCCH) by the group ID, and thus distributes the control data (PDCCH). Each wireless equipment 2 at first descrambles the CRC code of the control data (PDCCH) by the group ID, and determines whether the error detection of the control data (PDCCH) is normally finished. When able to normally receive the control data (PDCCH), the wireless equipment 2 searches for the segment area. The procedure of searching the segment area is the same as in Example 1. Through the procedure described above, the base station 1 is able to distribute the common control data (PDCCH) to the plurality of grouped wireless equipments 2. Other configurations and operation of Example 2 are the same as those of Example 1. The same components as those of Example 1 are marked with the same reference numbers and symbols, and their explanations are omitted. The system architecture and other equivalent elements in FIGS. 4 and 5 continue being used also in Example 2.

FIG. 10 illustrates a communication sequence of the communication system. FIG. 10 depicts the base station 1 (eNB) and the wireless equipment 2-1 through 2-4 (UE1 through UE4). Example 2 is also based on the premise that the RRC signaling is carried out before transmitting the data, and the connection between the base station 1 and the wireless equipment 2 is established (S1A). The RRC unit 1J (see FIG. 4) executing the process in S1A is one example of a “group notifying unit”. In Example 2, however, the RRC signaling involves distributing the group ID of the group to which the respective wireless equipments 2 belong in addition to the IDs of the wireless equipments 2.

The base station 1 assumes a case of occurrence of the data addressed to the wireless equipments 2-1, 2-2 and 2-4 belonging to a given group (S2). The base station 1 descrambles the CRC code of the control data (PDCCH) by the group ID of the group including the destination wireless equipments 2-1 and other equivalent equipments, and thus distributes the control data (PDCCH) (S3A). The PDCCH generating unit 1D, the L1 transmission unit 1E and the transmitter 1F (see FIG. 4), which transmit the control data (PDCCH), in the process of S3A, are one example of a “control data notifying unit”. Each of the wireless equipment 2-1 and other equivalent equipments performs the error detection by descrambling the CRC code by the group ID of the group to which the self equipment belongs, and thus acquires the control data (PDCCH) addressed to the self equipment (S3A). The receiver 2A, the L1 reception unit 2B, the PDCCH detection unit 2C and the PDCCH determining unit 2D (see FIG. 5), which receive the control data (PDCCH) in the process of S3A, are one example of a “control data reception unit”. The subsequent procedure is the same as in Example 1.

FIG. 11 illustrates a data transmission procedure to the wireless equipment 2, the procedure being performed by the base station 1. The base station 1, to begin with, determines whether the data addressed to the wireless equipment 2 belonging to each group occurs (P1A). Upon the occurrence of the data directed to the wireless equipment 2 belonging to a given group (“Y” in P1A), the base station 1 scrambles the CRC code by the group ID of the group concerned, and thus transmits the control data (PDCCH). The base station 1 further transmits the control data of the control Channel directed to the wireless equipment 2 and the data of the data Channel to the wireless equipment 2 (P2). Herein, the data area of the data Channel is segmented by the segment count, and the data (transport block) directed to the wireless equipment 2 is set. Next, the base station 1 monitors the uplink response signal Channel allocated to the wireless equipment 2 in the process of P2, and receives the response signal (P3). The processes from P3 onward are the same as those in Example 1.

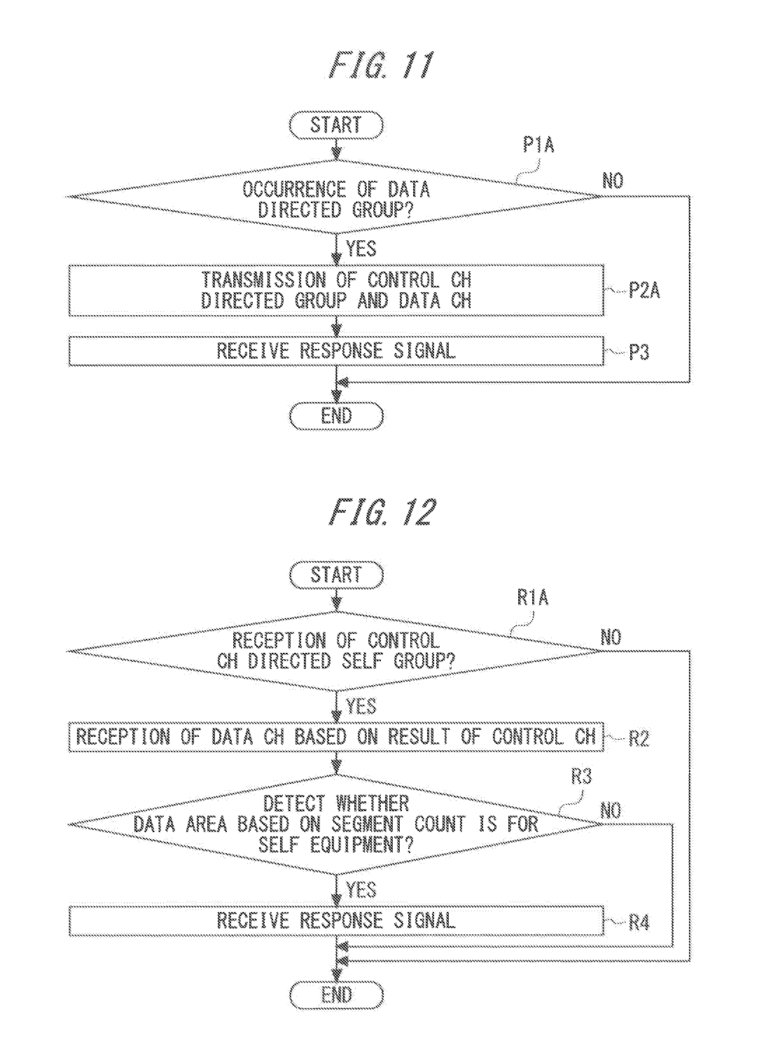

FIG. 12 depicts a reception procedure of the wireless equipment 2. To start with, the PDCCH detection unit 2C of the wireless equipment 2 receives the control data of the control Channel PDCCH directed to the self equipment (R1A). Similarly to Example, 1, the PDCCH detection unit 2C may simply detect the data of the control Channel (PDCCH) directed to the self equipment, based on whether the control data of the control Channel contains the group ID of the self group to which the self equipment belongs.

Upon receiving the data of the control Channel directed to the self group (“Y” in R1A), the PDCCH determining unit 2D of the wireless equipment 2 acquires the allocation of resources and other equivalent items of the data Channel (PDSCH) designated by the data of the control Channel. The PDSCH detection unit 21 of the wireless equipment 2 receives the data of the data Channel (PDSCH) in accordance with the designation of the data of the control Channel (R2). The processes from R2 onward are the same as those in Example 1.

As discussed above, the communication system in Example 2 enables the control Channel (PDCCH) to be distributed on a group-by-group basis by grouping the wireless equipments 2. In Example 2, the data area of the data Channel (PDSCH), via which the user data is transmitted, is segmented per wireless equipment 2 similarly to Example 1. As in Example 2, the base station 1 distributes the control data (PDCCH) on the group-by-group basis and is thereby enabled to the resource scheduling information and other equivalent information to the wireless equipments 2 without distributing the control data (PDCCH) per wireless equipment 2. In other words, each wireless equipment 2 of the communication system in Example 2 detects the segment area of the data Channel by the ID of the wireless equipment 2. The data area of the transmission unit data specified by the transmission time interval may be common within the group. Accordingly, the base station 1 is able to execute the process of distributing the control data (PDCCH) batch-wise on the group-by-group basis.

### Example 3

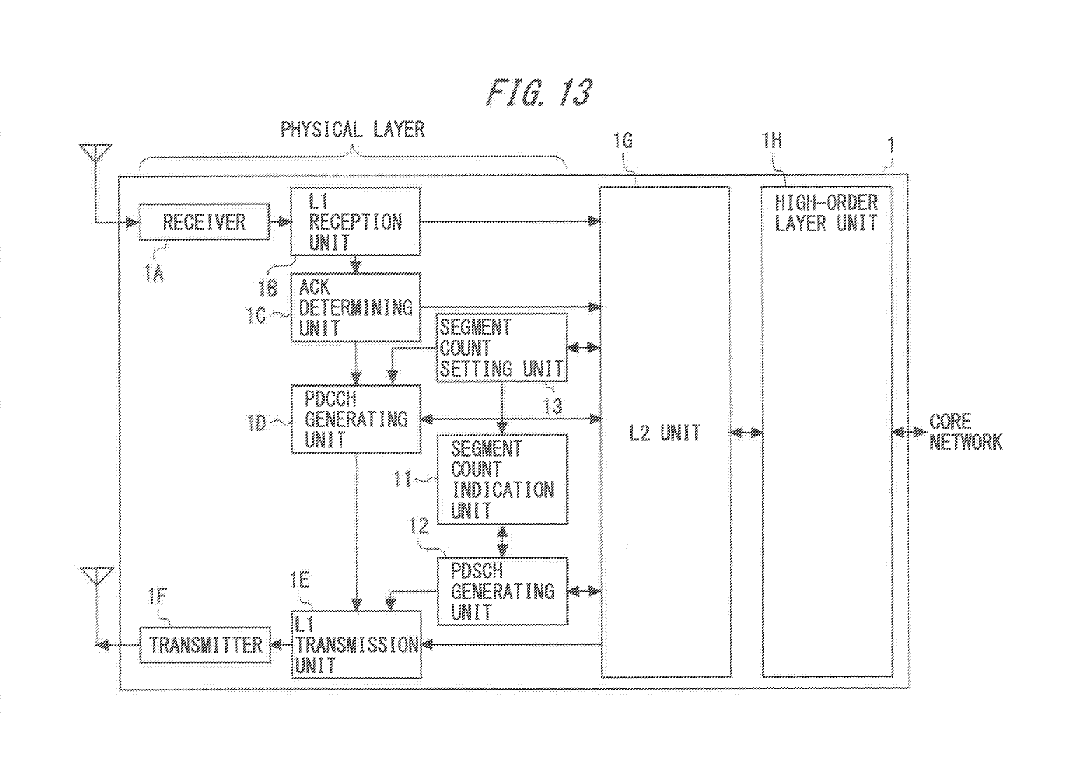

A communication system according to Example 3 will be described with reference to FIGS. 13 through 15. In Example 1 and Example 2, the data area in the sub-frame transmitted at the transmission time interval is segmented, and the data addressed to the different wireless equipments 2 are set in the segment areas. In Example 1 and Example 2, the segment count is preset based on the RRC signaling before being triggered by transmitting the data. Example 3 will discuss the communication system configured to set the segment count upon every trigger of the data transmission. Other configurations and operations in Example 3 are the same as those in Example 1 and Example 2. Such being the case, the same components of the communication system in Example 3 are marked with the same numerals and symbols as those in Example 1 and Example 2, and their explanations are omitted.

FIG. 13 illustrates system architecture of the base station 1 according to Example 3. The base station 1 in Example 3 includes, similarly to the base stations 1 in Example 1 and Example 2, the segment count setting unit 13, the segment count indication unit 11, the PDSCH generating unit 12 and the PDCCH generating unit 1D. The RRC unit 1J of the high-order layer unit 1H includes the segment count setting unit 13 in FIG. 4 of Example 1; and, however, the segment count setting unit 13 is encompassed by the physical layer in FIG. 13 of Example 3.

In FIG. 13 of Example 3, the segment count setting unit 13 sets the segment count in the PDCCH generating unit 1D and also sets the segment count in the segment count indication unit 11. The PDCCH generating unit 1D notifies the wireless equipment 2 of the segment count via the control Channel (PDCCH) per trigger of the data transmission.

Note that the segment count indication unit 11 receives the segment count set by the segment count setting unit 13, and hands over the segment count to the PDSCH generating unit 12. The PDSCH generating unit 12, when mapping the user data (transport block and other equivalent blocks) to the resource block, segments the data area in the sub-frame into the segment areas, based on the segment count retained by the segment count indication unit 11. The PDSCH generating unit 12 sets the user data addressed to the wireless equipment 2 in the segment area. The PDSCH generating unit 12 transmits the data area in the sub-frame, which is segmented into the segment area, to the wireless equipment 2 from the L1 transmission unit 1E. The configurations other than the configuration described above in FIG. 13 are the same as those in FIG. 4 in Example 1, and hence their explanations are omitted.

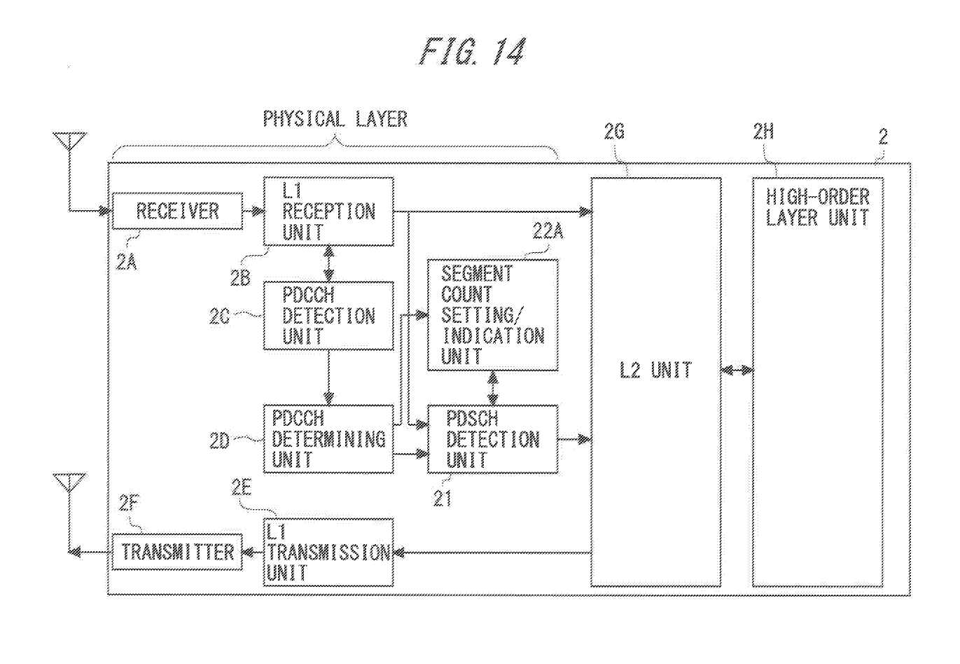

FIG. 14 illustrates the system architecture of the wireless equipment 2 according to Example 3. The wireless equipment 2 in Example 3 includes a segment count setting/indication unit 22A on the physical layer in place of the segment count setting unit 23 of the high-order layer unit 2H and the segment count indication unit 22 on the physical layer, which are included in the wireless equipment 2 in FIG. 5 of Example 1.

In Example 3, the PDCCH determining unit 2D acquires the segment count set by the base station 1 from the detected control Channel (PDCCH) addressed to the self equipment. The PDCCH determining unit 2D sets the acquire segment count in the segment count setting/indication unit 22A. the PDSCH detection unit 21 acquires the segment count from the segment count setting/indication unit 22A, searches for the data area in the sub-frame in accordance with the segment count, and thus acquires the user data (transport block) addressed to the self equipment. The configurations other than the configuration described above in FIG. 14 are the same as those in FIG. 5 in Example 1, and hence their explanations are omitted.

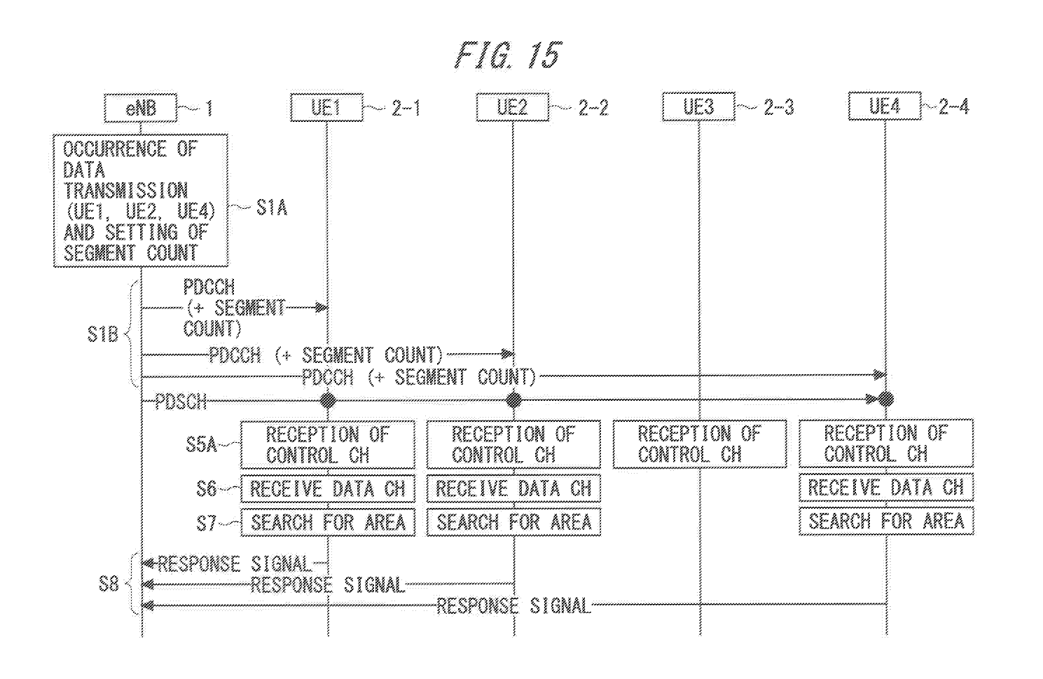

FIG. 15 illustrates a sequence diagram of the communication system in Example 3. FIG. 15 depicts the base station 1 (eNB) and the wireless equipments 2-1 through 2-4 (UE1 through UE4). Note that the RRC signaling is omitted in FIG. 15. The RRC signaling in Example 3 is the same signaling protocol as, e.g., 3GPP Standards.

On the other hand, in Example 3, the segment count is set when the base station 1 transmits the data (S1A). The segment count may be a previously fixed value. The segment count may also be a value that varies corresponding to the data size of the data to be transmitted. For example, the base station 1, when executing the process in S1A, may set the segment count to make receivable the maximum data in the data to be transmitted to the wireless equipments 2-1, 2-2, 2-4.

The base station 1 transmits the segment count to each wireless equipment 2 together with, e.g., the allocation information of the resource blocks via the control Channel (PDCCH) (S1B). The process in S1B is one example of a process of “notifying the wireless equipment of a segment designated value per trigger of data transmission”.

On the other hand, the wireless equipment 2-1 and other equivalent equipments acquire the segment count via the control Channel (PDCCH) (S5A). Next, the wireless equipment 2-1 and other equivalent equipments receive the data (sub-frame) of the data Channel (PDSCH), based on the scheduling information of the resource blocks in the control Channel (PDCCH). The wireless equipment 2-1 and other equivalent equipments search for the segment area form the data area in the received sub-frame by using the segment count acquired form the control Channel (PDCCH) (S7). The wireless equipment 2-1 and other equivalent equipments transmit the response signals to the base station 1 (S8).

As discussed above, according to the communication system in Example 3, the base station 1 notifies the wireless equipment 2 of the segment count at data transmission timing via the control Channel (PDCCH). On the other hand, the wireless equipment 2 acquires the segment count at every data reception timing via the control Channel (PDCCH). Hence, the communication system in Example 3 enables the base station 1 to set the segment count of the data area in the sub-frame flexibly per trigger of the data transmission.

[Other Modified Examples]

In Example 1, as illustrated in FIG. 2, when the segment count is set to “2”, the base station 1 classifies the data area in the sub-frame into the area with no segmentation and the segment areas into which to segment the data area by 2. Accordingly, the wireless equipment 2, when the segment count is 2, obtains the CRC code by searching for the data area on the assumption of the area with no segmentation and the segmented-by-2 segment areas, and thus performs the error detection. Likewise, as depicted in FIG. 3, when the segment count is set to “4”, the base station 1 classifies the data area in the sub-frame into the area with no segmentation, the segmented-by-2 segment areas or the segmented-by-4 segment areas. Therefore, the wireless equipment 2, when the segment count is 4, obtains the CRC code by searching for the data area on the assumption of the area with no segmentation, and the segmented-by-2 segment areas or the segmented-by-4 segment areas, and thus performs the error detection. To be specific, in Example 1 and Example 2, the segment count N is the maximum segment count, and the actual segmentation of the data area in the sub-frame entails the variation instanced by the N segmentation, the N/2 segmentation, the N/4 segmentation, . . . , the 2 segmentation and no segmentation. However, as a substitute for the procedure described above, the actual segment count may also be designated by the segment count N.

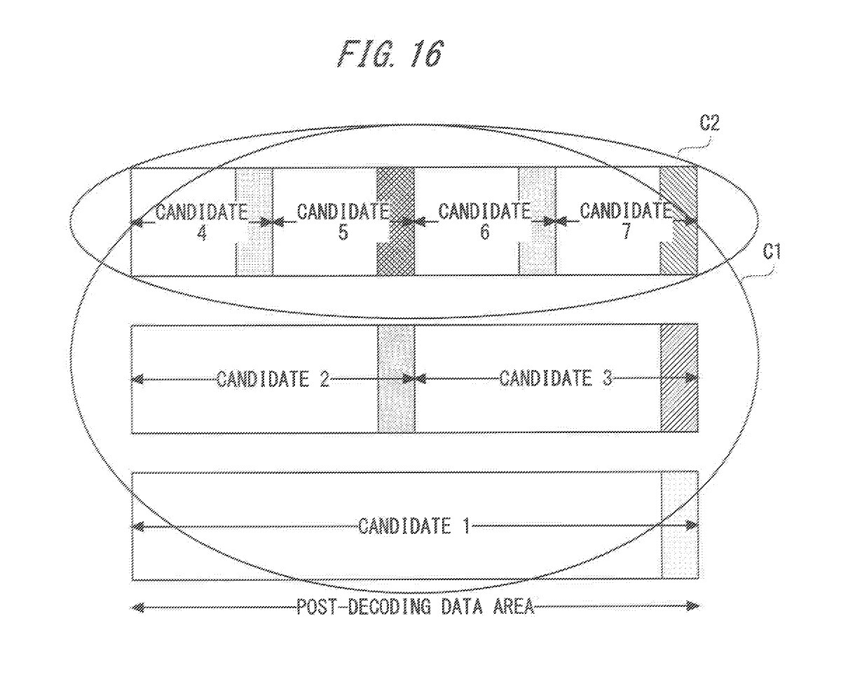

FIG. 16 illustrates a modified example of definition of the segment count. For instance, when the segment count is set to “4”, the definition in Example 1 and Example 2 permits no segmentation, the segmented-by 2, segment areas or the segmented-by-4 segment areas, which are encircled by an ellipse C1. In place of the definition as indicated by the ellipse C1, when the segment count is “4”, the base station 1 may set the segment areas so that the 4 segmentation indicated by an ellipse C2 is set, while the 2 segmentation and no segmentation are not set.

The wireless equipment 2 becomes easy to search for the segment area by setting the segment areas with the segment count N being fixed, as indicated by the ellipse C2 in FIG. 16. While on the other hand, as in Example 1 and Example 2, segment handling is done so that the segment count N implies the maximum segment count, the base station 1 is thereby enabled to flexibly set the segment areas.

[Resource Allocation for Uplink Response Signal]

Example 1 through example 3 mention none of the resource allocation for the uplink response signal. For example, as described in S8 of FIG. 8, the wireless equipment 2 recognizes the segment area with no error being detected as the segment area of the data addressed to the self equipment, and transmits the response signal back to the base station 1 via the uplink. The resource allocation of the uplink in this case may be carried out as below.

(Method 1) A method 1 is configured to allocate an arrangement location (resource element) in the uplink resource block as a resource for the uplink response signal, corresponding to an arrangement location (resource element) of PDCCH in the downlink resource block.

This allocation method may be implemented based on, e.g., a priori rule between the base station 1 and the wireless equipment 2. For example, as illustrated in S4 of FIG. 6, the wireless equipment 2, when able to recognize the data of the control Channel addressed to the self equipment on the radio resource block of the down link, may simply specify the symbol position on the radio resource block of the downlink. The wireless equipment 2 may also simply transmit the response signal indicated by the symbol on the radio resource block of the uplink back to the base station 1, the symbol corresponding to the specified symbol position of the control Channel on the radio resource block of the downlink. On the other hand, the base station 1 may simply acquire, as the response signal from the wireless equipment 2, the symbol on the radio resource block of the uplink, the symbol corresponding to the symbol position, transmitted to each wireless equipment 2, of the control Channel on the radio resource block of the downlink. The base station 1 may simply execute the retransmission process corresponding to ARQ (Automatic Repeat-reQuest) in response to this response signal.

(Method 2) A method 2 is configured to allocate the resource of the uplink response signal individually to every wireless equipment 2 by the RRC signaling or via the control Channel instanced by PDCCH and other equivalent channels. The base station 1, when notifying the wireless equipment 2 of the segment count by the RRC signaling illustrated in, e.g., FIG. 6, may simply designate the symbol on the radio resource block of the uplink as the resource of the uplink response signal. The base station 1, when notifying the wireless equipment 2 of the segment count via PDCCH as illustrated in, e.g., S1b of FIG. 15, may also simply designate the symbol on the radio resource block of the uplink as the resource of the uplink response signal.

(Method 3) A method 3 is configured to preset the resource corresponding to the segment count as the transmission resource of the uplink response signal. The base station 1 previously set the resource corresponding to the segment count, notifies the wireless equipment 2 of the preset resource together with the segment count, and allocates the resource of the uplink response signal, corresponding to the arrangement location of PDSCH. As described in Example 1, however, the segment count implies the maximum segment count N, and the base station 1 transmits the data of PDCCH by using the segment count smaller than the maximum segment count N, in which case part of the previously set resource is used.

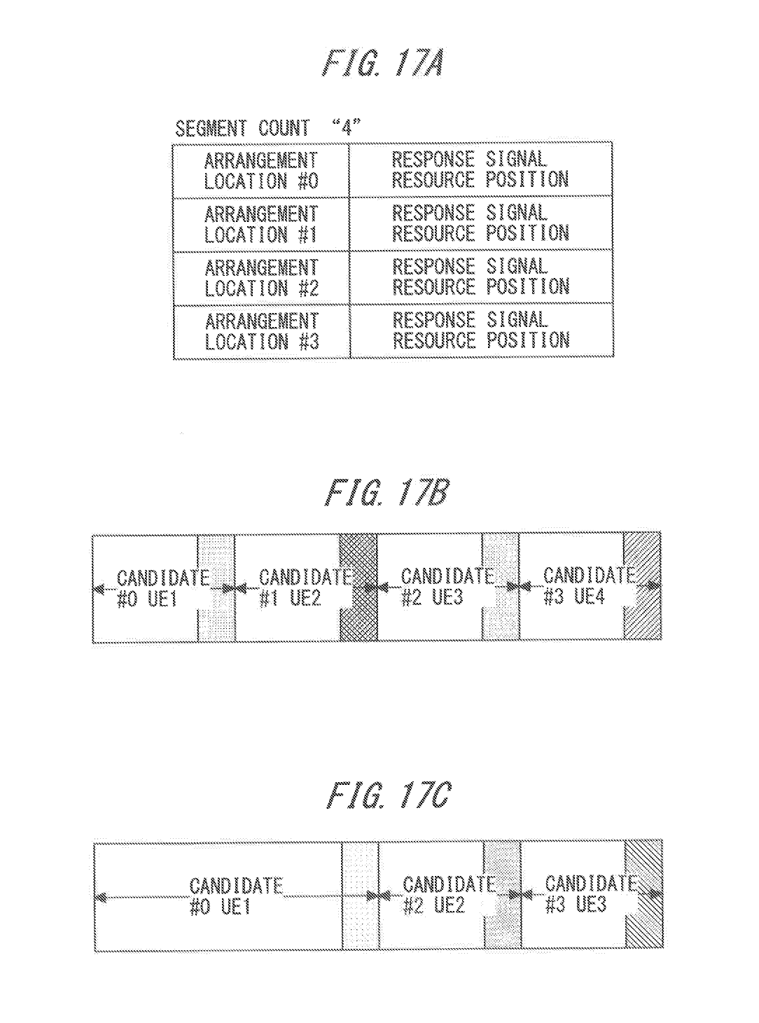

FIGS. 17A through 17C illustrate a resource allocation method of the uplink response signal according to the method 3. For example, when the segment count is “4”, the data area of the downlink data Channel is arranged as depicted in FIG. 17B. To be specific, the data area segmented by 4 at the maximum is set. Then, the base station 1 prepares four resource elements as the uplink response signals when transmitting the data of the data Channel containing the data area segmented by 4. The base station 1, when notifying the wireless equipment 2 of the segment count, notifies the wireless equipment 2 of positions of the prepared four resource elements for the uplink response signals together with the segment count.

FIG. 17A illustrates an information example of the positions, to be notified, of the four resource elements for the uplink response signals. In the example of FIG. 17A, identifying information (arrangement locations #0-#3) for identifying the four resource elements and the resource element designating information (response signal resource positions) are illustrated by being associated with each other. For instance, the arrangement location #0 is a piece of information for identifying the resource element for the uplink response signal corresponding to the segment area of the candidate #0 in FIG. 17B. Similarly, in FIG. 17A, the arrangement locations #1, #2, #3 are pieces of information for identifying the resource elements for the uplink response signals corresponding to the candidates #1, #2, #3 in FIG. 17B.

In FIG. 17A, the response signal resource position is a position of the resource element for the uplink response signal, and concretely subcarrier numbers and the symbol positions (e.g., 1 through 7) are designated.

Incidentally, the base station 1 notifies the wireless equipment 2 of the segment count, and the data area is actually designated by the segment count smaller than “4”, in which case the resources of the uplink response signals may be determined as follows. In FIG. 17C, the data area is segmented by 3 into a candidate 0, a candidate 2 and a candidate 3. The wireless equipment UE1 uses the candidate 0, the wireless equipment UE2 uses the candidate 2, and the wireless equipment UE3 uses the candidate 3. In this case, the wireless equipment UE1 using the candidate 0 is to employ the uplink resource element in the arrangement location #0. The wireless equipment UE2 using the candidate 2 is to employ the uplink resource element in the arrangement location #1. The wireless equipment UE3 using the candidate 3 is to employ the uplink resource element in the arrangement location #2. In other words, the identifying information (#0-#3) of the arrangement location indicated by #0-#3 may simply allocated sequentially from the smallest, i.e., in the sequence on the time axis (the candidates #0, #2, #3) of the actually used segment areas.

The base station 1 notifies the wireless equipment 2 of the allocation information of the uplink data Channel as in FIG. 17A, and may simply receive the uplink response signal from the wireless equipment 2. Note that the illustrations of FIGS. 17A-17C describe the case of the base station 1 notifying the wireless equipment 2 of the segment count. It does not, however, mean that the segment count is limited to “4” in allocating the transmission resource of the uplink response signal in the method 3. It may be sufficient that generally when the segment count=N, the base station 1, when notifying the wireless equipment 2 of the segment count N, notifies of the positions of the N-number of prepared resource elements for the uplink response signals together with the segment count N in the same format as in FIG. 17A. Actually, the data area of the downlink to the wireless equipment 2 from the base station 1 is segmented into an m-number, smaller than the N-number, of segment areas, in which case the wireless equipments 2 may simply transmit the uplink response signals by using the response signal resources designated by the arrangement locations #0-#m−1, corresponding to, e.g., the m-number of segment areas.

### EFFECT OF EMBODIMENT

The disclosed wireless communication system enables the base station to multiplex the radio resources with the smaller data quantity than the transmission unit data transmitted and received at the transmission time interval with respect to the wireless equipment after restraining the increase in data quantity for communication control.

What is claimed is:

1. A communication system comprising:
a base station; and
a plurality of wireless equipments,
the base station including:
a segment notifying unit that notifies each of the plurality of wireless equipments of a segment designated value used for segmenting a data area into a plurality of segment areas, the data area corresponding to a transmission time interval of a shared Channel to be time-multiplexed on a transmission time interval basis between the base station and the plurality of wireless equipments; and
a segment data setting unit that sets data addressed to the wireless equipment becoming a destination in the segment areas obtained by segmenting the data area based on the segment designated value,
each of the plurality of wireless equipments including:
a self equipment data acquiring unit that searches for the segment area containing data addressed to a self wireless equipment from the received data area of the shared Channel corresponding to the transmission time interval.

2. The communication system according to claim 1, wherein the segment data setting unit scrambles the segment area or a predetermined field of the segment area addressed to the destination wireless equipment by an identifier unique to the destination wireless equipment, and
the self equipment data acquiring unit determines whether the segment area is a segment area containing the data addressed to the self wireless equipment by descrambling the segment area or the predetermined field of the segment area in the received data areas by the identifier unique to the self wireless equipment.

3. The communication system according to claim 1, wherein the segment data setting unit sets the data addressed to the wireless equipment by segmenting the data area by a count smaller than the segment designated value to make a data capacity receivable of the data addressed to the wireless equipment when a data quantity addressed to the wireless equipment is larger than the data capacity of the segment area obtained by equally segmenting the data area by the segment designated value, and
the self equipment data acquiring unit searches for the segment area containing the data addressed to the self wireless equipment from the segment area obtained by segmenting the data area by the count smaller than the segment designated value when unable to acquire the data addressed to the self wireless equipment in the segment area obtained by equally segmenting the data area by the segment designated value.

4. The communication system according to claim 1, wherein the base station further includes:
a group notifying unit that notifies group identifying information to identify a group of the plurality of aggregated wireless equipments to each wireless equipment of each group of wireless equipments; and
a control data notifying unit that notifies of allocation of the data area corresponding to the transmission time interval of the shared Channel batch-wise per group, and
each of the wireless equipments further includes:
a control data reception unit that receives the allocation of the data area corresponding to the transmission time interval of the shared Channel by using identifying information of every group.

5. The communication system according to claim 1, wherein the segment notifying unit notifies the wireless equipment of the segment designated value per trigger of call setting.

6. The communication system according to claim 1, wherein the segment notifying unit notifies the wireless equipment of the segment designated value per trigger of data transmission.

7. A base station comprising:
a segment notifying unit that notifies each of the plurality of wireless equipments of a segment designated value used for segmenting a data area into a plurality of segment areas, the data area corresponding to a transmission time interval of a shared Channel to be time-multiplexed on a transmission time interval basis between the base station and the plurality of wireless equipments; and
a segment data setting unit that sets data addressed to the wireless equipment becoming a destination in the segment areas obtained by segmenting the data area based on the segment designated value.

8. The base station according to claim 7, wherein the segment data setting unit scrambles the segment area or a predetermined field of the segment area addressed to the destination wireless equipment by an identifier unique to the destination wireless equipment.

9. The base station according to claim 7, wherein the segment data setting unit sets the data addressed to the wireless equipment by segmenting the data area by a count smaller than the segment designated value to make a data capacity receivable of the data addressed to the wireless equipment when a data quantity addressed to the wireless equipment is larger than the data capacity of the segment area obtained by equally segmenting the data area by the segment designated value.

10. The base station according to claim 7, further comprising:
a group notifying unit that notifies group identifying information to identify a group of the plurality of aggregated wireless equipments to each wireless equipment of each group of wireless equipments; and
a control data notifying unit that notifies of allocation of the data area corresponding to the transmission time interval of the shared Channel batch-wise per group.

11. The base station according to claim 7, wherein the segment notifying unit notifies the wireless equipment of the segment designated value per trigger of call setting.

12. The base station according to claim 7, wherein the segment notifying unit notifies the wireless equipment of the segment designated value per trigger of data transmission.

13. A wireless equipment comprising:
a segment count reception unit that receives a segment designated value used for segmenting a data area into a plurality of segment areas, the data area corresponding to a transmission time interval of a shared Channel to be time-multiplexed on a transmission time interval basis between a base station and a plurality of wireless equipments; and
a self equipment data acquiring unit that searches for the segment area containing data addressed to a self wireless equipment from the received data area of the shared Channel corresponding to the transmission time interval.

14. The wireless equipment according to claim 13, wherein the self equipment data acquiring unit determines whether the segment area is a segment area containing the data addressed to the self wireless equipment by descrambling the segment area or the predetermined field of the segment area in the received data areas by the identifier unique to the self wireless equipment.

15. The wireless equipment according to claim 13, wherein the self equipment data acquiring unit searches for the segment area containing the data addressed to the self wireless equipment from the segment area obtained by segmenting the data area by the count smaller than the segment designated value when unable to acquire the data addressed to the self wireless equipment in the segment area obtained by equally segmenting the data area by the segment designated value.

16. The wireless equipment according to claim 13, further comprising a control data reception unit that receives the allocation of the data area corresponding to the transmission time interval of the shared Channel by using identifying information of every group.

17. A communication method comprising:
notifying, by which a base station executes processing, each of a plurality of wireless equipments of a segment designated value used for segmenting a data area into a plurality of segment areas, the data area corresponding to a transmission time interval of a shared Channel to be time-multiplexed on a transmission time interval basis between the base station and the plurality of wireless equipments;
setting, by which the base station executes processing, data addressed to the wireless equipment becoming a destination in the segment areas obtained by segmenting the data area based on the segment designated value; and
searching, by which each of the plurality of wireless equipments executes processing, for the segment area containing data addressed to a self wireless equipment from the received data area of the shared Channel corresponding to the transmission time interval.

18. The communication method according to claim 17, further comprising:
scrambling, by which the base station executes processing, the segment area or a predetermined field of the segment area addressed to the destination wireless equipment by an identifier unique to the destination wireless equipment; and
determining, by which each of the wireless equipments executes processing, whether the segment area is a segment area containing the data addressed to the self wireless equipment by descrambling the segment area or the predetermined field of the segment area in the received data areas by the identifier unique to the self wireless equipment.

19. The communication method according to claim 17, further comprising:
setting, by which the base station executes processing, the data addressed to the wireless equipment by segmenting the data area by a count smaller than the segment designated value to make a data capacity receivable of the data addressed to the wireless equipment when a data quantity addressed to the wireless equipment is larger than the data capacity of the segment area obtained by equally segmenting the data area by the segment designated value; and
searching, by which each of the wireless equipments executes processing, for the segment area containing the data addressed to the self wireless equipment from the segment area obtained by segmenting the data area by the count smaller than the segment designated value when unable to acquire the data addressed to the self wireless equipment in the segment area obtained by equally segmenting the data area by the segment designated value.

20. The communication method according to claim 17, further comprising:
notifying, by which the base station executes processing, group identifying information to identify a group of the plurality of aggregated wireless equipments to each wireless equipment of each group of wireless equipments;
notifying, by which the base station executes processing, of allocation of the data area corresponding to the transmission time interval of the shared Channel batch-wise per group; and
receiving, by which each of the wireless equipments executes processing, the allocation of the data area corresponding to the transmission time interval of the shared Channel by using identifying information of every group.

21. The communication method according to claim 17, further comprising notifying, by which the base station executes processing, the wireless equipment of the segment designated value per trigger of call setting.

22. The communication method according to claim 17, further comprising notifying, by which the base station executes processing, the wireless equipment of the segment designated value per trigger of data transmission.
